(19) United States
(12) Patent Application Publication
(10) Pub. No.: US 2026/0100360 A1
(43) Pub. Date: Apr. 9, 2026

(54) POSITIVE ELECTRODE ACTIVE MATERIAL, POSITIVE ELECTRODE, SECONDARY BATTERY, ELECTRONIC DEVICE, AND VEHICLE

(71) Applicant: SEMICONDUCTOR ENERGY LABORATORY CO., LTD., Atsugi-shi (JP)

(72) Inventors: Kunihiko SUZUKI, Isehara (JP); Yohei MOMMA, Isehara (JP); Mayumi MIKAMI, Atsugi (JP); Tatsuyoshi TAKAHASHI, Atsugi (JP); Yuji IWAKI, Isehara (JP)

(21) Appl. No.: 19/365,357

(22) Filed: Oct. 22, 2025

Related U.S. Application Data
(63) Continuation of application No. 17/995,374, now abandoned.

(30) Foreign Application Priority Data
Apr. 10, 2020 (JP) 2020-071077

(51) Int. Cl. H01M 4/485; H01M 4/02; H01M 4/04; H01M 4/62; H01M 10/0525

(52) U.S. Cl. CPC H01M 4/485; H01M 4/0404; H01M 4/625; H01M 10/0525; H01M 2004/021; H01M 2004/028; H01M 2220/20

(57) ABSTRACT

A positive electrode active material with high charge and discharge capacity is provided. A positive electrode active material with high charge and discharge voltage is provided. A secondary battery which hardly deteriorates is provided. A highly safe power storage device is provided. A novel secondary battery is provided. The positive electrode active material contains cobalt, oxygen, and fluorine and includes a bond of the cobalt and the fluorine in a surface portion or the vicinity of a grain boundary. By having the bond with fluorine, at least part of cobalt is high-spin (paramagnetic) Co²⁺. Thus, in ESR analysis, the spin concentration at 113 K is higher than the spin concentration at 300 K by 1.1×10⁻⁵ spins/g or more.

### CROSS REFERENCE TO RELATED APPLICATIONS

This application is a continuation of U.S. application Ser. No. 14/922,753, filed Oct. 26, 2015, currently pending, which is incorporated by reference and is a U.S. National Phase Application under 35 U.S.C. § 371 of International Application PCT/IB2021/052673, filed on Mar. 31, 2021, which is incorporated by reference and claims the benefit of a foreign priority application filed in Japan on Apr. 10, 2020, as Application No. 2020-071077.

### TECHNICAL FIELD

Embodiments of the present invention relate to a secondary battery including a positive electrode active material and a manufacturing method thereof. Other embodiments of the present invention relate to a portable information terminal, a vehicle, and the like each including a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a positive electrode active material has been studied to increase the cycle performance and the capacity of the lithium-ion secondary battery (e.g., Patent Document 1). A technique called electron spin resonance (ESR) or electron paramagnetic resonance (EPR) is useful in analyzing the state of a transition metal included in a positive electrode active material (e.g., Non-Patent Document 1).

The performances required for lithium-ion secondary batteries are safe operation and longer-term reliability under various environments, for example.

### REFERENCES

### Patent Document

[Patent Document 1] Japanese Published Patent Application No. 2000-12022

### Non-Patent Document

[Non-Patent Document 1] Fe³⁺ and Ni³⁺ impurity distribution and electrochemical performance of LiCoO₂ electrode materials for lithium ion batteries, R. Alcantara et al, Journal of Power Sources 194 (2009) 494-501

### SUMMARY OF THE INVENTION

### Problems to be Solved by the Invention

An object of one embodiment of the present invention is to provide a positive electrode active material exhibiting favorable rate performance. Another object of one embodiment of the present invention is to provide a positive electrode active material with high charge and discharge capacity. Another object is to provide a positive electrode active material with high charge and discharge voltage. Another object is to provide a positive electrode active material which hardly deteriorates. Another object is to provide a novel positive electrode active material. Another object is to provide a secondary battery with high charge and discharge capacity. Another object is to provide a secondary battery with high charge and discharge voltage. Another object is to provide a highly safe or reliable secondary battery. Another object is to provide a secondary battery which hardly deteriorates. Another object is to provide a long-life secondary battery. Another object is to provide a novel secondary battery.

Another object of one embodiment of the present invention is to provide an active material, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a positive electrode active material including cobalt, oxygen, and fluorine, and the positive electrode active material includes a bond of the cobalt and the fluorine in a surface portion or the vicinity of a grain boundary.

Another embodiment of the present invention is a positive electrode active material including lithium, cobalt, oxygen, and fluorine, in which part of the cobalt is divalent in a discharged state.

Another embodiment of the present invention is a positive electrode active material including cobalt, oxygen, and fluorine, in which at least part exhibits a paramagnetic property.

In the above-described positive electrode active material, in a range of a g value obtained in an electron spin resonance spectrum of greater than or equal to 2.068 and less than or equal to 2.233, the spin concentration at a temperature of 113 K is higher than the spin concentration at a temperature of 300 K by 1.1×10⁻⁵ spins/g or more.

In the above-described positive electrode active material, an approximate straight line with three or more measured values at temperatures of higher than or equal to 113 K and lower than or equal to 300 K is drawn in a graph of the inverse of the temperature and the spin concentration per cobalt ion, the slope of the straight line is more than or equal to 5×10⁻⁶ and less than or equal to 4×10⁻⁵.

Another embodiment of the present invention is a positive electrode including a positive electrode active material, a conductive material, and a current collector. The positive electrode active material includes cobalt, oxygen, and fluorine. The conductive material includes carbon. In a range of a g value obtained in an electron spin resonance spectrum of the positive electrode active material of greater than or equal to 2.068 and less than or equal to 2.233, the spin concentration at a temperature of 113 K is higher than the spin concentration at a temperature of 300 K by 1.1×10⁻⁵ spins/g or more.

Another embodiment of the present invention is a secondary battery including the above-described positive electrode active material.

Another embodiment of the present invention is an electronic device including the above-described secondary battery.

Another embodiment of the present invention is a vehicle including the above-described secondary battery.

### Effect of the Invention

With one embodiment of the present invention, a positive electrode active material exhibiting favorable rate performance can be provided. With one embodiment of the present invention, a positive electrode active material with high charge and discharge capacity can be provided. Furthermore, a positive electrode active material with high charge and discharge voltage can be provided. Furthermore, a positive electrode active material which hardly deteriorates can be provided. Furthermore, a novel positive electrode active material can be provided. Furthermore, a secondary battery with high charge and discharge capacity can be provided. Furthermore, a secondary battery with high charge and discharge voltage can be provided. Furthermore, a highly safe or reliable secondary battery can be provided. Furthermore, a secondary battery which hardly deteriorates can be provided. Furthermore, a long-life secondary battery can be provided. Furthermore, a novel secondary battery can be provided.

With one embodiment of the present invention, an active material, a power storage device, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1 is a diagram illustrating the magnetism of cobalt.

FIG. 2A to FIG. 2B2 are diagrams illustrating a model used for calculation of lithium extraction energy.

FIG. 3A to FIG. 3B2 are diagrams illustrating a model used for calculation of lithium extraction energy.

FIG. 4 is a graph showing calculation results of the lithium transfer barrier.

FIG. 5A to FIG. 5C are diagrams illustrating a model used for calculation of the DOS.

FIG. 6A and FIG. 6B are graphs showing calculation results of the DOS.

FIG. 7A and FIG. 7B are graphs showing calculation results of the DOS.

FIG. 8A and FIG. 8B are graphs showing calculation results of the DOS.

FIG. 9A and FIG. 9B are graphs showing calculation results of the DOS.

FIG. 10A and FIG. 10B are graphs showing calculation results of the DOS.

FIG. 11A and FIG. 11B are graphs showing calculation results of the DOS.

FIG. 12A and FIG. 12B are graphs showing calculation results of the DOS.

FIG. 13 is a graph showing calculation results of the DOS.

FIG. 14 is a diagram illustrating a method for forming a positive electrode active material.

FIG. 15 is a diagram illustrating a method for forming a positive electrode active material.

FIG. 16 is a diagram illustrating a method for forming a positive electrode active material.

FIG. 17 is a diagram illustrating a method for forming a positive electrode active material.

FIG. 18A and FIG. 18B are cross-sectional views of an active material layer containing a graphene compound as a conductive material.

FIG. 19A and FIG. 19B are diagrams illustrating examples of a secondary battery.

FIG. 20A to FIG. 20C are diagrams illustrating an example of a secondary battery.

FIG. 21A and FIG. 21B are diagrams illustrating an example of a secondary battery.

FIG. 22A to FIG. 22C are diagrams illustrating a coin-type secondary battery.

FIG. 23A to FIG. 23D are diagrams illustrating a cylindrical secondary battery.

FIG. 24A and FIG. 24B are diagrams illustrating an example of a secondary battery.

FIG. 25A to FIG. 25D are diagrams illustrating examples of the secondary battery.

FIG. 26A and FIG. 26B are diagrams illustrating examples of the secondary battery.

FIG. 27 is a diagram illustrating an example of the secondary battery.

FIG. 28A to FIG. 28C are diagrams illustrating a laminated secondary battery.

FIG. 29A and FIG. 29B are diagrams illustrating a laminated secondary battery.

FIG. 30 is an external view of the secondary battery.

FIG. 31 is an external view of the secondary battery.

FIG. 32A to FIG. 32C are diagrams illustrating a method for manufacturing a secondary battery.

FIG. 33A to FIG. 33H are diagrams illustrating examples of electronic devices.

FIG. 34A to FIG. 34C are diagrams illustrating an example of an electronic device.

FIG. 35 is a diagram illustrating examples of electronic devices.

FIG. 36A to FIG. 36C are diagrams illustrating examples of electronic devices.

FIG. 37A to FIG. 37C are diagrams illustrating examples of electronic devices.

FIG. 38A to FIG. 38C are diagrams illustrating examples of vehicles.

FIG. 39 shows an ESR spectrum of a positive electrode active material in Example.

FIG. 40 shows an ESR spectrum of a positive electrode active material in Example.

FIG. 41 shows an ESR spectrum of a positive electrode active material in Example.

FIG. 42 is a graph showing spin concentrations of positive electrode active materials in Example.

FIG. 43 is a graph showing spin concentrations of positive electrode active materials in Example.

FIG. 44 is a graph of the spin concentration per cobalt ion and the inverse of the temperature of the positive electrode active materials in Example.

FIG. 45A and FIG. 45B show charge and discharge curves of secondary batteries in Example.

FIG. 46 shows discharge capacity of the secondary batteries in Example.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is a region that is less than or equal to 50 nm, preferably less than or equal to 35 nm, further preferably less than or equal to 20 nm, most preferably less than or equal to 10 nm inward from the surface, for example. A plane generated by a split or a crack may also be referred to as a surface. In addition, a region in a deeper position than a surface portion is referred to as an inner portion. In this specification and the like, a grain boundary refers to a portion where particles adhere to each other, a portion where crystal orientation changes inside a particle, a portion including many defects, a portion with a disordered crystal structure, or the like. The grain boundary can be regarded as a plane defect. The vicinity of a grain boundary refers to a region positioned within 10 nm from the grain boundary. In this specification and the like, particles are not necessarily spherical (with a circular cross section). Other examples of the cross-sectional shapes of particles include an ellipse, a rectangle, a trapezoid, a conical or pyramidal shape, a quadrilateral with rounded corners, and an asymmetrical shape, and a particle may have an indefinite shape.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and, in some cases, not only (hkl) but also (hkil) is used as the Miller index. Here, i is −(h+k).

In this specification and the like, the layered rock-salt crystal structure of a composite oxide including lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

Anions of a layered rock-salt crystal and anions of a rock-salt crystal have a cubic close-packed structure (face-centered cubic lattice structure).

Note that in this specification and the like, a structure where three layers of anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in electron diffraction or fast Fourier transform (FFT) of a TEM image or the like, a spot may appear in a position slightly different from a theoretical position. For example, anions may be regarded as forming a cubic close-packed structure when a difference in orientation from a theoretical position is 5 degrees or less or 2.5 degrees or less.

When a layered rock-salt crystal and a rock-salt crystal are in contact with each other, there is a crystal plane at which orientations of cubic close-packed structures composed of anions are aligned with each other.

The description can also be made as follows. Anions on the (111) plane of a cubic crystal structure has a triangular arrangement. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangular lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other.”

Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal; thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

The orientations of crystals in two regions being substantially aligned with each other can be judged, for example, from a TEM (Transmission Electron Microscope) image, a STEM (Scanning Transmission Electron microscope) image, a HAADF-STEM (High-angle Annular Dark Field Scanning TEM) image, an ABF-STEM (Annular Bright-Field Scanning Transmission Electron microscopy) image, electron diffraction, and FFT of a TEM image or the like. XRD (X-ray Diffraction), neutron diffraction, and the like can also be used for judging.

In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines is 5 degrees or less or 2.5 degrees or less in the TEM image, it can be judged that the crystal planes are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having the layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5 degrees or less or 2.5 degrees or less in a HAADF-STEM image, it can be judged that arrangements of the atoms are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the depth of charge obtained when all the lithium that can be inserted and extracted is inserted is 0, and the depth of charge obtained when all the lithium that can be inserted and extracted in a positive electrode active material is extracted is 1. A positive electrode active material with a depth of charge of greater than or equal to 0.7 and less than or equal to 0.9 may be referred to as a positive electrode active material charged with a high voltage. Furthermore, a positive electrode active material with a depth of charge of less than or equal to 0.06 or a positive electrode active material from which more than or equal to 90% of the charge capacity is discharged from a state where the positive electrode active material is charged with a high voltage is referred to as a sufficiently discharged positive electrode active material.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

In this specification and the like, an approximate value of a given value A refers to a value greater than or equal to 0.94 and less than or equal to 1.1A.

In this specification and the like, an example in which a lithium metal is used as a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. The secondary battery of one embodiment of the present invention using a lithium counter electrode is charged and discharged at a voltage higher than a general charge voltage of approximately 4.6 V in some cases; however, charging and discharging may be performed at a lower voltage. Charging and discharging at a lower voltage may lead to the cycle performance better than that described in this specification and the like.

### Embodiment 1

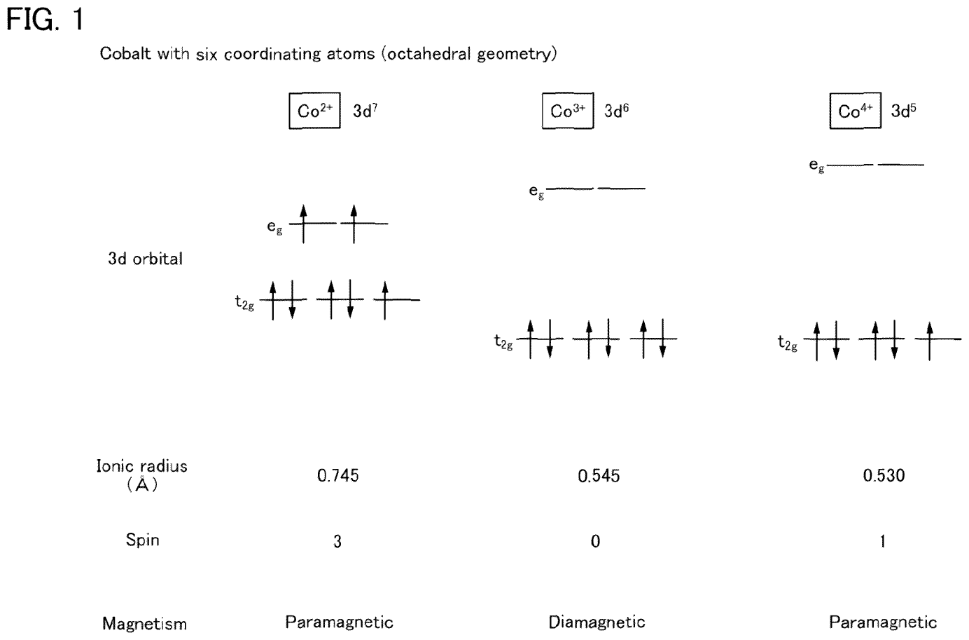

In this embodiment, a positive electrode active material 100 that is one embodiment of the present invention is described with reference to FIG. 1 to FIG. 8.

### <Contained Element>

The positive electrode active material 100 contains lithium, a transition metal M, oxygen, and an additive. The positive electrode active material 100 can be regarded as a composite oxide represented by LiMO₂ to which an additive is added. Note that the composition is not strictly limited to Li:M:O=1:1:2 as long as the positive electrode active material of one embodiment of the present invention has a crystal structure of a lithium composite oxide represented by LiMO₂.

As the transition metal M contained in the positive electrode active material 100, a metal that can form, together with lithium, a composite oxide having the layered rock-salt structure belonging to the space group R-3m is preferably used. For example, at least one of manganese, cobalt, and nickel can be used. Specifically, using cobalt at greater than or equal to 75 atomic %, preferably greater than or equal to 90 atomic %, further preferably greater than or equal to 95 atomic % as the transition metal M contained in the positive electrode active material 100 brings many advantages such as relatively easy synthesis, easy handling, and excellent cycle performance.

As the additive contained in the positive electrode active material 100, at least one of halogen (e.g., fluorine or chlorine), an alkaline earth metal (e.g., magnesium or calcium), a Group 13 element (e.g., boron, aluminum, or gallium), a Group 4 element (e.g., titanium, zirconium, or hafnium), a Group 5 element (e.g., vanadium or niobium), a Group 3 element (e.g., scandium or yttrium), lanthanoid (e.g., lanthanum, cerium, neodymium, or samarium), iron, chromium, cobalt, arsenic, zinc, silicon, sulfur, and phosphorus is preferably used. These elements further stabilize a crystal structure included in the positive electrode active material 100 in some cases, as described later. The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive may be rephrased as a mixture, a constituent of a material, an impurity, or the like.

Note that an alkaline earth metal (e.g., magnesium or calcium), a Group 13 element (e.g., boron, aluminum, or gallium), a Group 4 element (e.g., titanium, zirconium, or hafnium), a Group 5 element (e.g., vanadium or niobium), a Group 3 element (e.g., scandium or yttrium), iron, chromium, cobalt, arsenic, zinc, silicon, sulfur, or phosphorus is not necessarily contained as the additive.

The positive electrode active material 100 of one embodiment of the present invention preferably contains at least cobalt as the transition metal M and at least fluorine as the additive element. A bond of cobalt and fluorine is particularly preferably included in a surface portion of the positive electrode active material 100. In other words, in the surface portion or the vicinity of a grain boundary, fluorine is preferably substituted for part of oxygen of LiCoO₂ to form LiCoO₂₋ₓFₓ (0.01≤x≤1); as a result, part of Co³⁺ close to the fluorine is preferably changed to Co²⁺. The concentration of Co²⁺ in the surface portion or the vicinity of the grain boundary is preferably sufficiently high to, for example, such an extent to cause a spin-spin interaction between unpaired electrons of the closest cobalt atoms at 100 K or lower. Furthermore, cation vacancies in an amount corresponding to the substituted fluorine may be present for balanced cations. In this specification and the like, unless otherwise specified, the valence of cobalt refers to that in a discharged state, that is, in a state where lithium is sufficiently inserted. The state where lithium is sufficiently inserted means the state where 99% or more of the charge capacity is discharged, for example.

### <Magnetism>

Whether Co³⁺ and Co²⁺ are contained at preferable concentrations in the positive electrode active material 100 can be analyzed by Electron Spin Resonance (ESR) in the following manner, for example.

Cobalt in the layered rock-salt structure, the rock-salt structure, or the like has octahedral geometry with six coordinating anions. Thus, as illustrated in FIG. 1, the 3d orbital is split into the e_{g} orbital and the t_{2g} orbital. Of the both orbitals, the t_{2g} orbital located aside from the direction in which the anions exist has lower energy.

High-spin Co²⁺ has three unpaired electrons and exhibits a paramagnetic property. Co²⁺ may have a low-spin configuration; in this case, Co²⁺ has one unpaired electron and exhibits a paramagnetic property. In the case of low-spin Co³⁺, the t_{2g} orbital is fully occupied and a diamagnetic property is exhibited. In the case of low-spin Co⁴⁺, Co⁴⁺ has one unpaired electron and exhibits a paramagnetic property.

The behavior of the magnetic susceptibility χ due to a temperature change differs between the diamagnetic property and the paramagnetic property. With the diamagnetic property, the magnetic susceptibility χ does not change between room temperature (e.g., approximately 300 K) and low temperature (e.g., 113 K). In contrast, with the paramagnetic property, the magnetic susceptibility χ increases from room temperature toward low temperature. With the higher magnetic susceptibility χ, the ESR signal intensity increases. Thus, the observed spin concentration is increased.

In the case where the positive electrode active material contains cobalt and there is a region where paramagnetic Co²⁺ exists at a preferable concentration in diamagnetic Co³⁺, the magnetic susceptibility χ of the positive electrode active material follows the Curie-Weiss law (1) shown below. Here, C represents the Curie constant, and θ represents the Weiss constant.

$$[ Formula 1 ]$$

$$χ = \frac{C}{T - θ} \qquad ( 1 )$$

In this case, at room temperature, that is, approximately 300 K, spins of the unpaired electrons are disordered, and a paramagnetic property is exhibited. Up to approximately 100 K, the magnetic susceptibility χ increases with the inverse of the temperature, in a manner similar to that of the simple Curie law. As well as the magnetic susceptibility χ, the ESR signal intensity and the number of spins increase with the inverse of the temperature.

At a temperature lower than approximately 100 K, long-range order due to the interaction between magnetic spins of Co²⁺ is gradually generated. The ESR signal intensity increases in accordance with the Curie law; however, the influence of the interaction between magnetic spins becomes larger and the ESR signal becomes less likely to be observed and broader.

At even lower temperatures, complete long-range order is exhibited, and the ESR signal is no more observed.

In the ESR spectra in a g value range from 2.068 to 2.233 inclusive, the positive electrode active material 100 of one embodiment of the present invention preferably has a higher spin concentration at 113 K than the spin concentration at 300 K. The difference in spin concentration is preferably 1.1×10⁻⁵ spins/g or more, further preferably 2.5×10⁻⁵ spins/g or more, still further preferably 4.0×10⁻⁵ spins/g or more.

Note that the g value range from 2.068 to 2.233 inclusive may be rephrased as the magnetic field range from 295 mT to 318.5 mT inclusive with a microwave frequency of, for example, 9.22 GHz.

In a graph of the inverse of the temperature, which is from 113 K to 300 K, and the spin concentration per cobalt ion of the positive electrode active material 100 of one embodiment of the present invention, three or more measured values are preferably on a straight line. Specifically, in the case where the three or more measured values are approximated to a straight line, the coefficient of determination R² of the approximate straight line is preferably more than or equal to 0.9. The slope of the approximate straight line is preferably more than or equal to 5×10⁻⁶, further preferably more than or equal to 7×10⁻⁶. Furthermore, the slope of the approximate straight line is preferably less than or equal to 4×10⁻⁵.

With the above-described relation between the temperature and the spin concentration, the positive electrode active material 100 can be regarded as exhibiting a paramagnetic property. Thus, it can be judged that there is a region where paramagnetic Co²⁺ exists at a preferable concentration in diamagnetic Co³⁺ in the positive electrode active material 100. Furthermore, it can be judged that, in the surface portion or the vicinity of the grain boundary of the positive electrode active material 100, fluorine is substituted for part of oxygen of LiCoO₂ to form LiCoO₂₋ₓFₓ. (0.01≤x≤1). Moreover, it can be judged that a bond of cobalt and fluorine is included in the surface portion or the vicinity of the grain boundary of the positive electrode active material 100.

Of the cobalt with six coordinating atoms, Co²⁺ and Co⁴⁺ both have an unpaired electron and Co³⁺ does not have an unpaired electron as illustrated in FIG. 1. Since ESR analysis observes spin flip of unpaired electrons, ESR cannot distinguish between Co²⁺ and Co⁴⁺ by itself. Thus, the valence of cobalt is preferably determined referring also to the other analysis results of X-ray photoelectron spectroscopy (XPS), electron energy loss spectroscopy (EELS), energy dispersive X-ray spectroscopy (EDX), an electron probe X-ray microanalyzer (EPMA), or the like. For example, in the case where the positive electrode active material 100 includes a region sufficiently containing lithium and fluorine, for example, a region containing lithium and fluorine at 5 atomic % or more in total and spin flip of unpaired electrons of cobalt is observed, it can be judged that LiCoO₂₋ₓFₓ (0.01≤x≤1) is contained and Co²⁺ is contained. In the case where spin flip of an unpaired electron of cobalt is observed in spite of a poor amount of lithium and fluorine in the positive electrode active material after charging and discharging, it can be judged that CoO₂ is partly contained and Co⁴⁺ is contained.

CoO, Co₃O₄, or the like might be generated and Co²⁺ might be generated also in the case of a significant lithium shortage. However, in that case, a change arises such as the ratio between elements contained in the positive electrode active material being changed to a large extent in the analysis such as ICP-MS or the charge and discharge characteristics being greatly decreased. Thus, the case of containing CoO, Co₃O₄, or the like and the case of containing LiCoO₂₋ₓFₓ (0.01≤x≤1) can be distinguished from each other. Furthermore, for example, also in the case where the peak corresponding to the (003) plane of the layered rock-salt crystal structure is greatly lowered in the XRD analysis, it can be judged that CoO, Co₃O₄, or the like is generated.

Whether to include the region sufficiently containing lithium and fluorine can be judged by the XPS analysis on the positive electrode active material 100, for example. The XPS can analyze a region of particle from its surface to a depth of more than or equal to 2 nm and less than or equal to 8 nm (usually about 5 nm). If containing lithium and fluorine at 5 atomic % or more in total in the XPS analysis, the surface portion can be regarded as including a region sufficiently containing lithium and fluorine.

Furthermore, it is preferable that the positive electrode active material 100 of one embodiment of the present invention sufficiently contain fluorine, LiCoO₂₋ₓFₓ (0.01≤x≤1), and Co²⁺ in the surface portion or the vicinity of the grain boundary; however, the same does not necessarily apply to the inner portion. The inner portion preferably retains the layered rock-salt crystal structure because, when the inner portion retains the layered rock-salt crystal structure, many lithium sites contributing to charging and discharging can be secured and the charge and discharge capacity of a secondary battery can be large.

Thus, paramagnetic Co³⁺ of LiCoO₂ preferably occupies a large part of the cobalt in the inner portion. Since the paramagnetic Co³⁺ does not have an unpaired electron, an excessive spin concentration suggests a small amount of LiCoO₂ and difficulty in retaining the layered rock-salt crystal structure.

Note that different ESR spectra are expected between the case of analyzing only the positive electrode active material 100 and the case of analyzing a positive electrode active material layer containing a conductive material and a binder. For example, it is expected that a signal of the positive electrode active material 100 and a signal derived from a carbon-based material contained in the conductive material overlapping with each other are observed. However, the g value, g_{//}, g⊥, and the like of the ESR spectra of carbon-based materials, for example, fibrous carbon materials such as acetylene black, graphite, graphene, and carbon nanotubes are known. Furthermore, the ESR spectrum of acetylene black in the positive electrode active material layer had g=2.001 and a Δ Peak-to Peak of approximately 1 mT with a microwave of 9.22 GHz. Furthermore, it has been found that the spins of Co²⁺ and Co⁴⁺ in LiCoO₂ have g=approximately 2.14 and a Δ peak-to peak of approximately 3 mT to 5 mT with a microwave of 9.22 GHz. Thus, by separating a signal derived from cobalt of the positive electrode active material 100 and a signal derived from a carbon-based material, it is quite possible to judge the cobalt magnetism.

### <Lithium Extraction Energy>

When, in the surface portion or the vicinity of the grain boundary of the positive electrode active material 100, fluorine is substituted for part of oxygen of LiCoO₂ to form LiCoO₂₋ₓFₓ (0.01≤x≤1), lithium extraction energy becomes small as described later. Thus, using such a positive electrode active material 100 in a secondary battery is preferable because the charge and discharge characteristics, rate performance, and the like are improved.

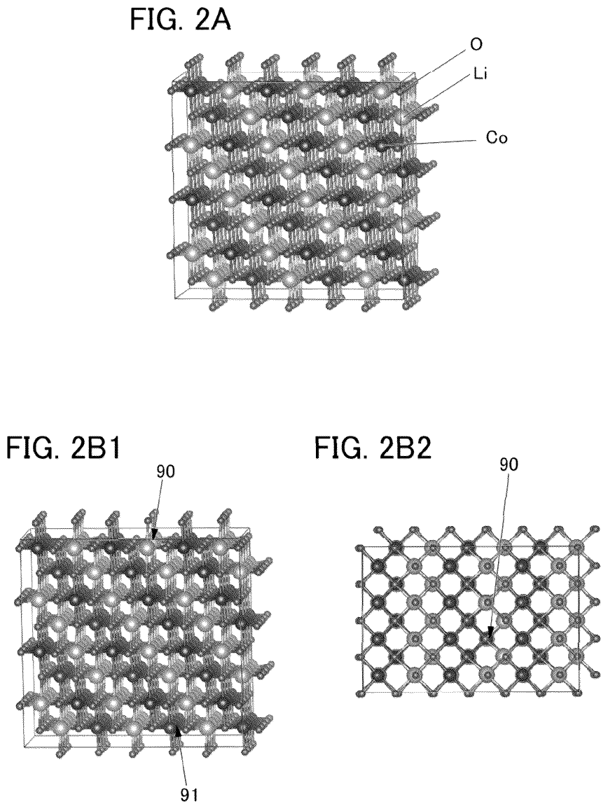

FIG. 2A illustrates a LiCoO₂ model not containing fluorine. In this case, every cobalt is trivalent and has a low-spin configuration.

FIG. 2B1 and FIG. 2B2 illustrate a model obtained by extracting one lithium from the model of FIG. 2A. A lithium vacancy 90 is indicated by arrows. One of cobalt atoms located near the lithium vacancy 90 is tetravalent. The tetravalent cobalt 91 is indicated by an arrow.

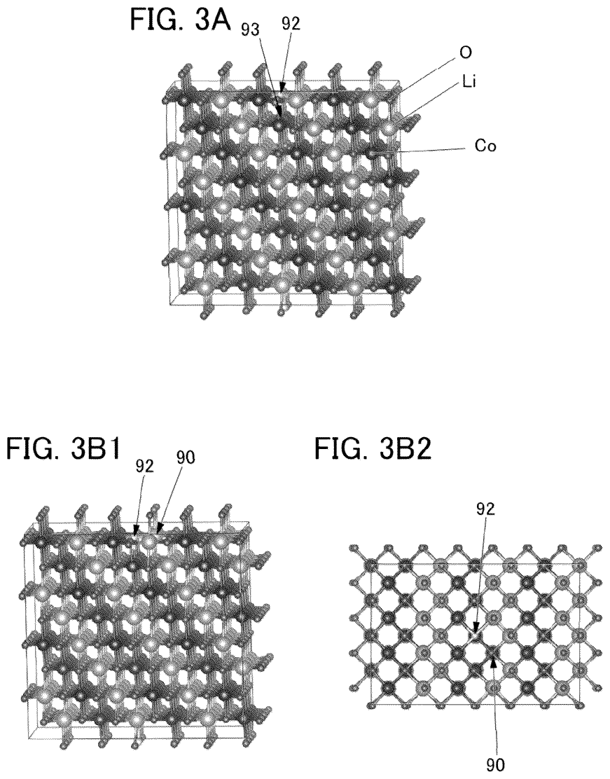

Next, FIG. 3A illustrates a LiCoO₂₋ₓFₓ (0.01≤x≤1) model obtained by substituting fluorine for one of oxygen atoms. A fluorine-substituted position 92 is indicated by an arrow. One of cobalt atoms located close to the fluorine is divalent. The divalent cobalt 93 is indicated by an arrow.

FIG. 3B1 and FIG. 3B2 illustrate a model obtained by extracting one lithium from the model of FIG. 3A. The lithium vacancy 90 is indicated by arrows. In this case, every cobalt is trivalent.

The energy of the above-described models was calculated. The calculation conditions are listed in Table 1. From the calculation results, the difference in energy between before and after extraction of one lithium atom, that is, lithium extraction energy was obtained and shown in Table 2.

TABLE 1

| Software | VASP |
|---|---|
| Functional | GGA + U (DFT-D2) |
| Pseudopotential | PAW |
| Cut-off energy (eV) | 600 |
| U potential (eV) | Co 4.91 |
| Number of atoms | [Before Li extraction] |
| | Without F: 96 Li atoms, 96 Co atoms, 192 O atoms |
| | With F: 96 Li atoms, 96 Co atoms, 191 O |
| | atoms, 1 F atom |
| | [After Li extraction] |
| | Without F: 95 Li atoms, 96 Co atoms, 192 O atoms |
| | With F: 95 Li atoms, 96 Co atoms, 191 O |
| | atoms, 1 F atom |
| k-points | 1 × 1 × 1 |

TABLE 2

| Model | Without F | With F |
|---|---|---|
| Valence of Co | Co³⁺→Co⁴⁺ | Co²⁺→Co³⁺ |
| (Beore Li extraction→After | | |
| one Li atom extraction) | | |
| Li extraction energy | 6.90 eV | 5.46 eV |

As shown in Table 2, the lithium extraction energy of the model with the substituted fluorine for part of oxygen is lower than that of the model not containing fluorine by 1.54 eV. This is because the change in the valence of cobalt ions associated with lithium extraction is trivalent to tetravalent in the case of not containing fluorine and divalent to trivalent in the case of containing fluorine, and the oxidation-reduction potential differs therebetween.

Thus, when LiCoO₂₋ₓFₓ (0.01≤x≤1) is included in the surface portion of the positive electrode active material 100, extraction of lithium ions in the vicinity of fluorine is likely to occur smoothly. Thus, using such a positive electrode active material 100 in a secondary battery is preferable because the charge and discharge characteristics, rate performance, and the like are improved.

Although the difference in stabilization energy between before and after the lithium extraction is stated as the lithium extraction energy in the above description, a similar energy difference occurs also when lithium is inserted. Thus, improvements in charge and discharge characteristics, rate performance, and the like are similarly expected in discharging as well as in charging.

### <Lithium Transfer Barrier>

Next, in the surface portion or the vicinity of the grain boundary of the positive electrode active material 100, the difference in conductivity of lithium ions, that is, the difference in the lithium transfer barrier, between the case of LiCoO₂ not containing fluorine and the case of LiCoO₂₋ₓFₓ (0.01≤x≤1) obtained by substituting fluorine for part of oxygen of LiCoO₂ was calculated.

When a lithium ion moves (diffuses) from a position to a nearby stable site, the lithium ion travels beyond an energy barrier due to electron repulsion or attraction from the surrounding ions (e.g., cobalt ions or oxygen ions). The energy was calculated at each position in the lithium path by an NEB (Nudged elastic band) method. Here, the highest energy corresponds to the barrier.

When a lithium ion overcomes the energy barrier from the initial position and reaches the transfer end position, it is called lithium ion hopping. The repetition of this lithium ion hopping generates lithium conduction. Here, the energy barrier in one-time lithium ion hopping was calculated, and the lithium-ion transfer easiness was evaluated. The lower barrier (height of energy peak) is more advantageous for lithium-ion conductivity.

The calculation conditions are listed in Table 3.

TABLE 3

| Sofware | VASP |
|---|---|
| Functional | GGA + U (DFT-D2) |
| Pseudopotential | PAW |
| Cut-off energy (eV) | 600 |
| U potential (eV) | Co 4.91 |
| Number of atoms | Without F: 1 Li atom, 48 Co atoms, 96 O atoms |
| | With F: 1 Li atom, 48 Co atoms, 95 O |
| | atoms, 1 F atom |
| k-points | 1 × 1 × 1 |
| Calculation target | Lattice and atomic position optimized for |
| | the initial configuration |
| | Lattice optimized after a NEB (Nudged Elastic |
| | Band) method for the diffusion process |

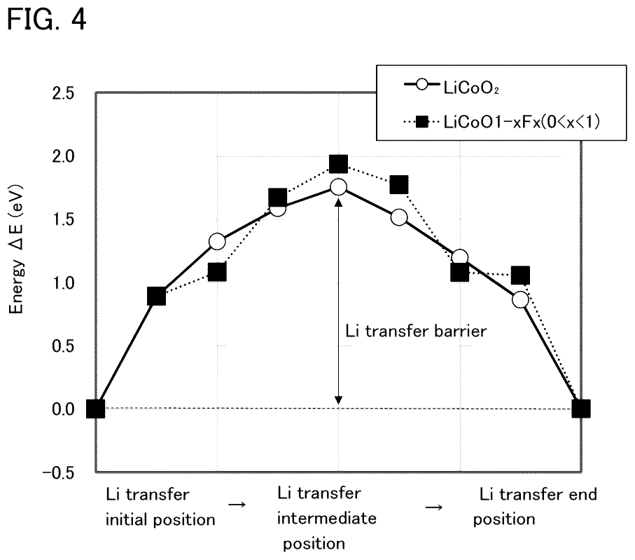

The calculation results are shown in FIG. 4. As shown in FIG. 4, LiCoO₂ (without F) and LiCoO₂₋ₓFₓ (0.01≤x≤1) (with F) had almost the same lithium-ion transfer barrier, demonstrating that containing fluorine in the surface portion or the vicinity of the grain boundary of the positive electrode active material 100 does not inhibit lithium-ion conduction.

### <Density of States (DOS)>

Next, the partial densities of states (PDOS) of the case of LiCoO₂ (without F), the case of LiCoO₂₋ₓFₓ (0.01≤x≤1) (with F), and the case where one lithium atom is extracted from LiCoO₂₋ₓFₓ (0.01≤x≤1) (with F) were calculated.

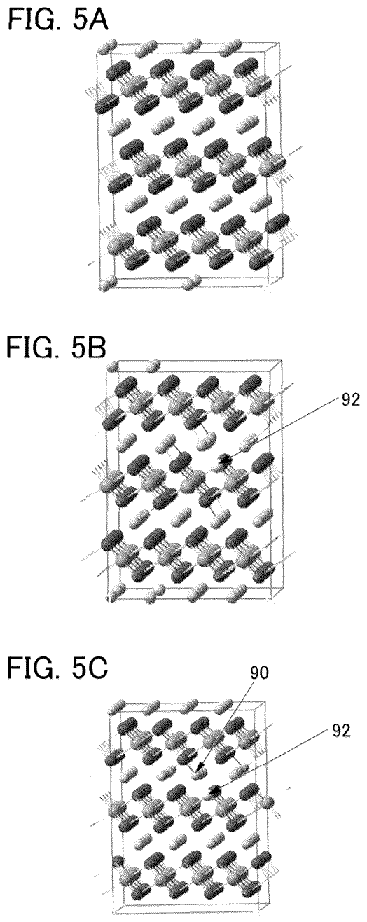

FIG. 5A illustrates a LiCoO₂ (without F) model without any substitution. FIG. 5B illustrates a LiCoO₂₋ₓFₓ (0.01≤x≤1) (with F) model with substituted F for one of oxygen atoms. The fluorine-substituted position 92 is indicated by an arrow. FIG. 5C illustrates a model in which one more lithium atom is extracted from the model of FIG. 5B. The lithium vacancy 90 is indicated by an arrow.

The calculation conditions are listed in Table 4. In calculation of each model, the Fermi level was assumed to be 0. The Fermi level of each model is shown in Table 5.

TABLE 4

| Software | VASP |
|---|---|
| Functional | GGA + U (DFT-D2) |
| Pseudopotential | PAW |
| Cut-off energy (eV) | 600 |
| U potential (eV) | Co 4.91 |
| Number of atoms | With F: 48 Li atoms, 48 Co atoms, 96 O atoms |
| | Without F: 48 Li atoms, 48 Co atoms, 95 O |
| | atoms, 1 F atom |
| k-points | 3 × 3 × 3 |

TABLE 5

| | With Li |
|---|---|
| Model | (R − 3m) |
| No substitution | 5.865 eV |
| LiCoO₂ | |
| F substitution | 6.430 eV |
| LiCoO₂₋ₓFₓ (0.01 ≤ x ≤ 1) | |
| F substitution − Li | 5.890 eV |
| One Li atom is extracted from | |
| LiCoO₂₋ₓFₓ (0.01 ≤ x ≤ 1) | |

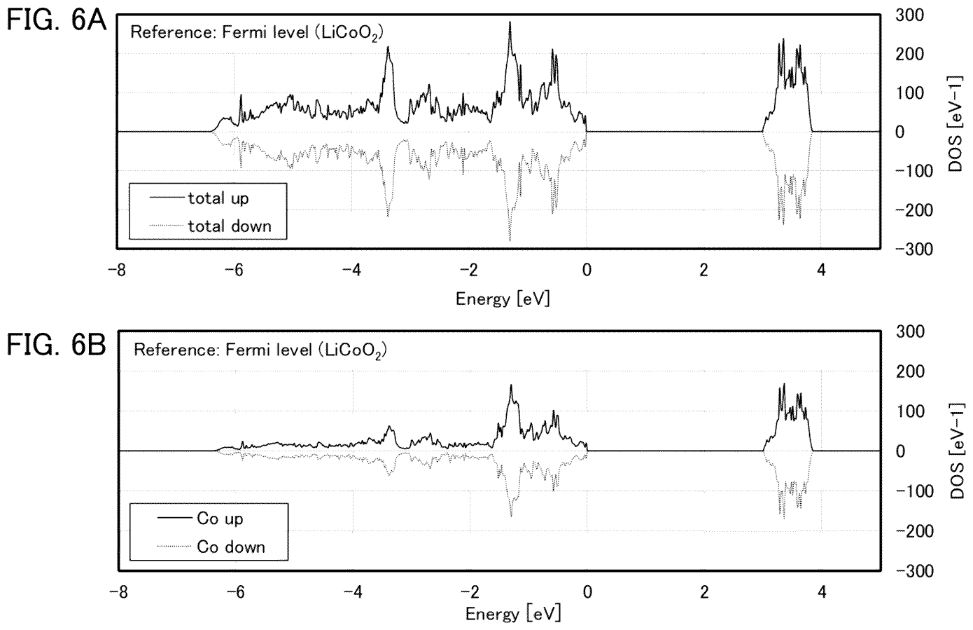

The calculation results are shown in FIG. 6A to FIG. 13.

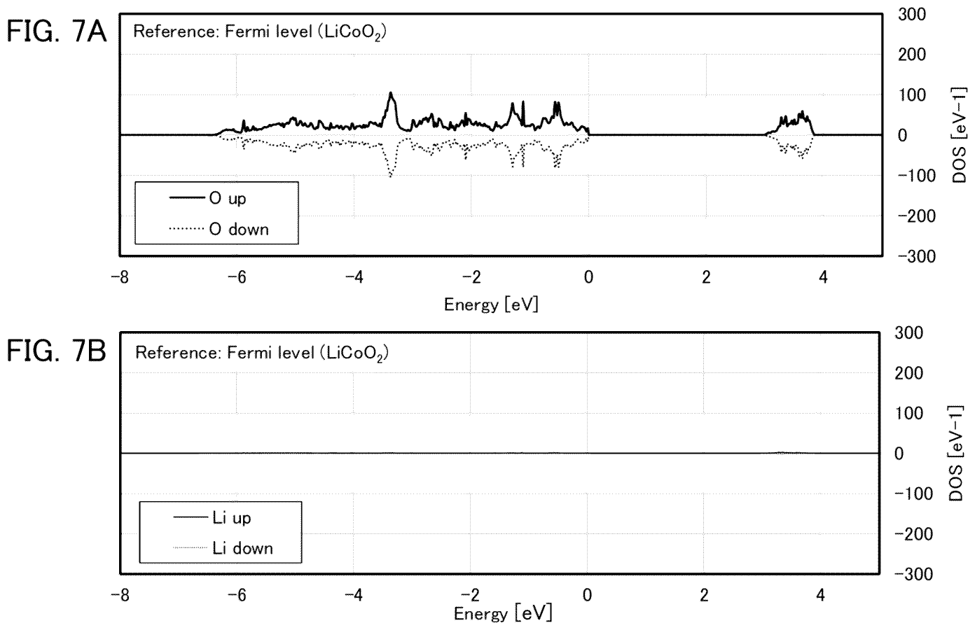

FIG. 6A to FIG. 7B show the PDOS of LiCoO₂ without any substitution. FIG. 6A, FIG. 6B, FIG. 7A, and FIG. 7B show the PDOS of the total, cobalt (Co), oxygen (O), and lithium (Li), respectively.

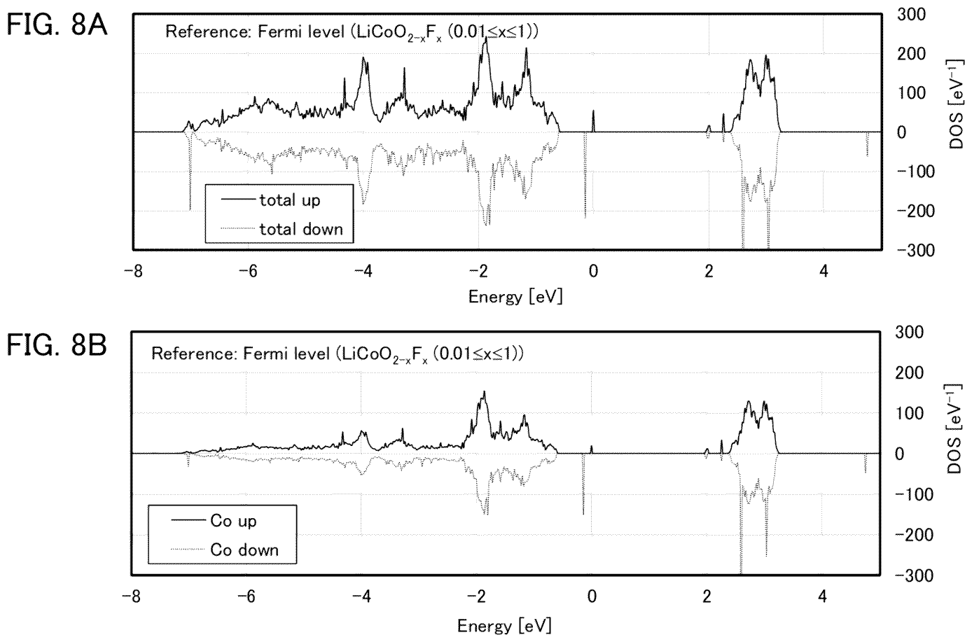

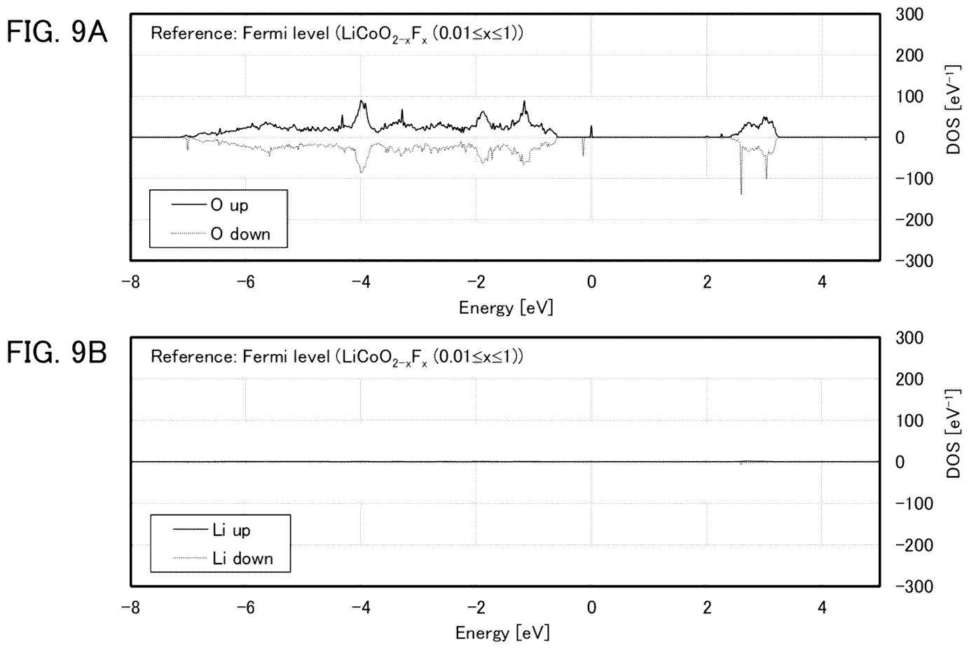

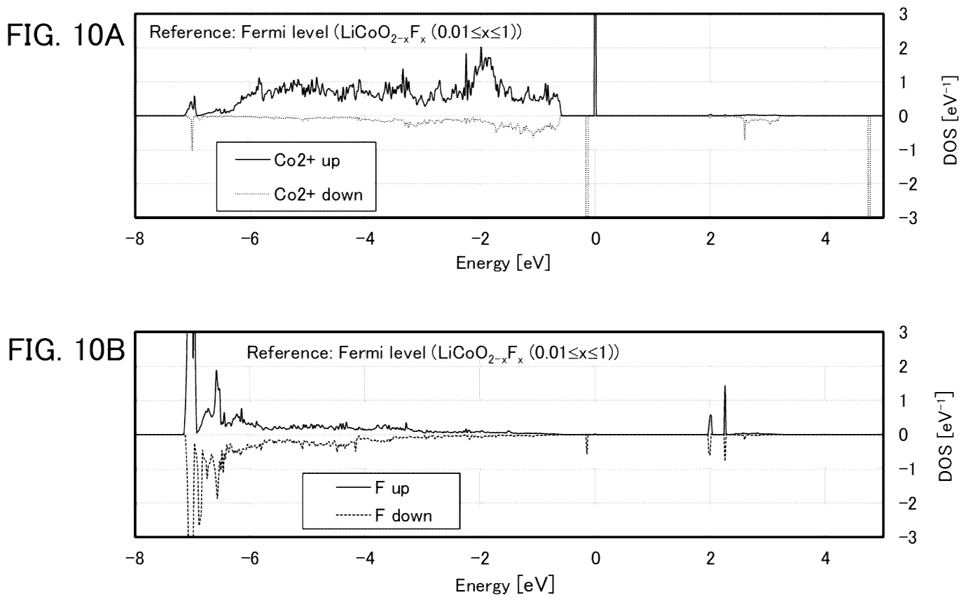

FIG. 8A to FIG. 10B show the PDOS of LiCoO₂₋ₓFₓ (0.01≤x≤1) where fluorine is substituted for one of oxygen atoms. FIG. 8A, FIG. 8B, FIG. 9A, FIG. 9B, FIG. 10A, and FIG. 10B show the PDOS of the total, cobalt, oxygen, lithium, divalent cobalt (Co²⁺), and fluorine (F), respectively. The scale of the vertical axis in FIG. 10A and FIG. 10B is different from that in the other graphs.

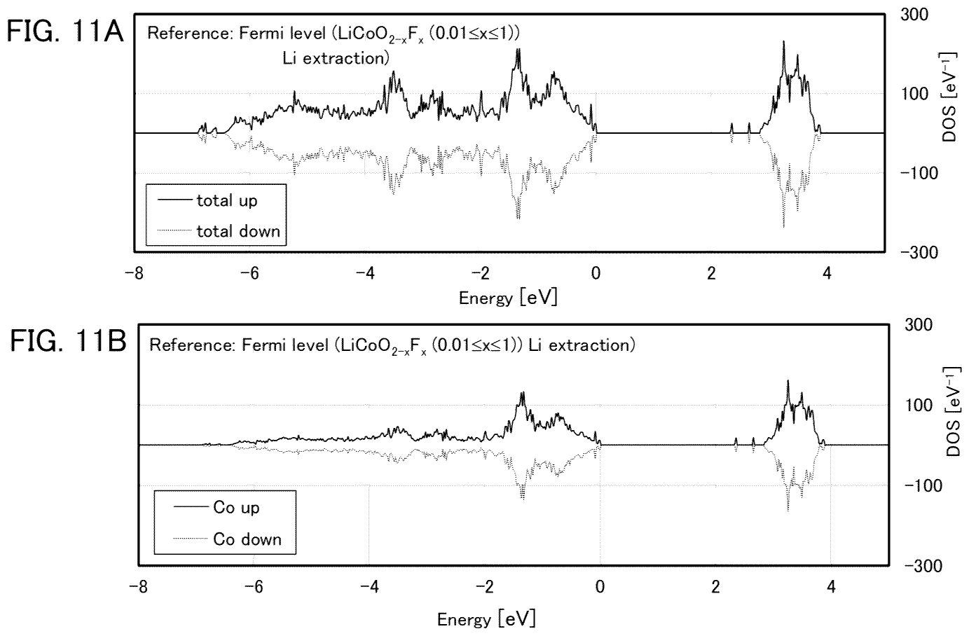

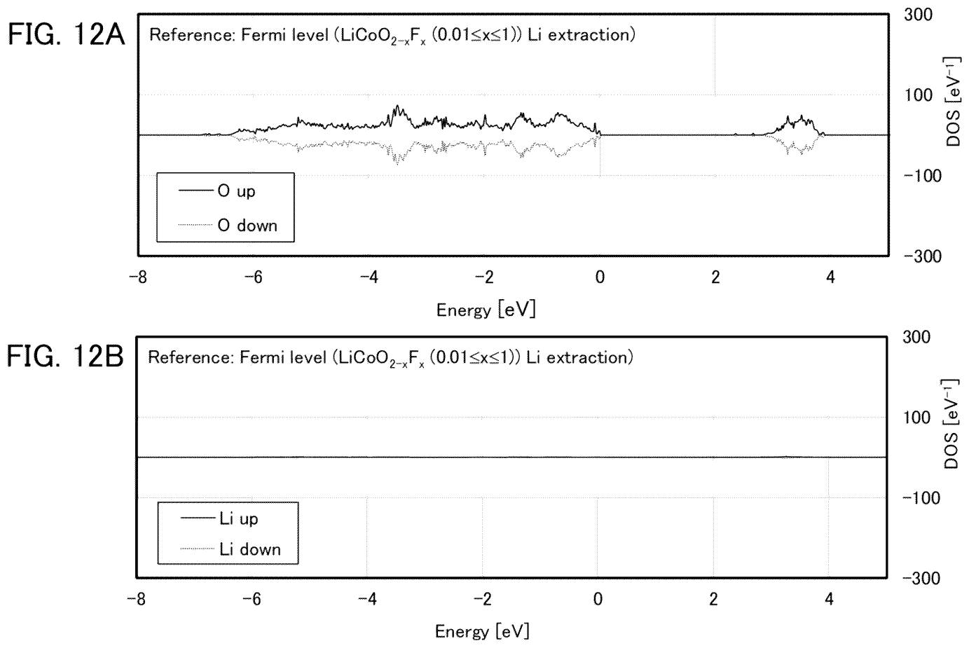

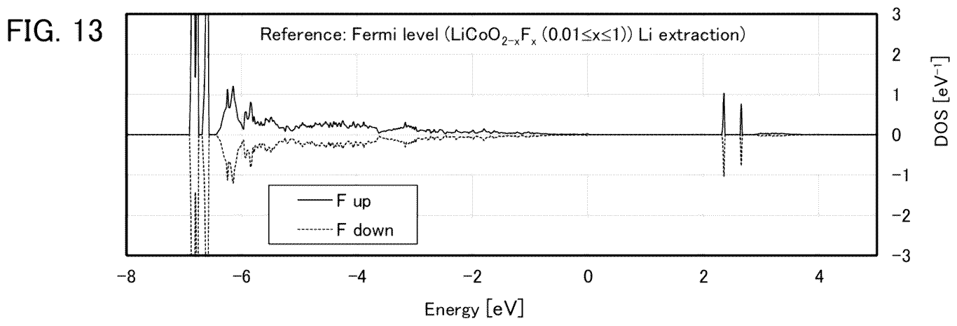

FIG. 11A to FIG. 13 show the DOS of the case where one lithium atom is extracted from LiCoO₂₋ₓFₓ (0.01≤x≤1) where fluorine is substituted for one of oxygen atoms. FIG. 11A, FIG. 11B, FIG. 12A, FIG. 12B, and FIG. 13 show the PDOS of the total, cobalt, oxygen, lithium, and fluorine, respectively.

As shown in FIG. 6B, spin-up and spin-down bands derived from cobalt in LiCoO₂ are symmetrical, showing that the cobalt is low-spin diamagnetic Co³⁺.

In contrast, as shown in FIG. 8(B) and FIG. 10(A), spin-up and spin-down bands derived from cobalt in LiCoO₂₋ₓFₓ (0.01≤x≤1) are asymmetrical, which is owing to one cobalt being high-spin paramagnetic Co²⁺. Since Co²⁺ has electrons in the e_{g} orbital, the Fermi level becomes high as shown in Table 5.

Furthermore, as shown in FIG. 11B, in the case where one lithium atom is extracted from LiCoO₂₋ₓFₓ (0.01≤x≤1), spin-up and spin-down bands derived from cobalt are symmetrical, showing that the cobalt is low-spin diamagnetic Co³⁺. In other words, FIG. 8B, FIG. 10A, and FIG. 11B show that extraction of one lithium causes a change from Co²⁺ to Co³⁺.

This embodiment can be used in combination with the other embodiments.

### Embodiment 2

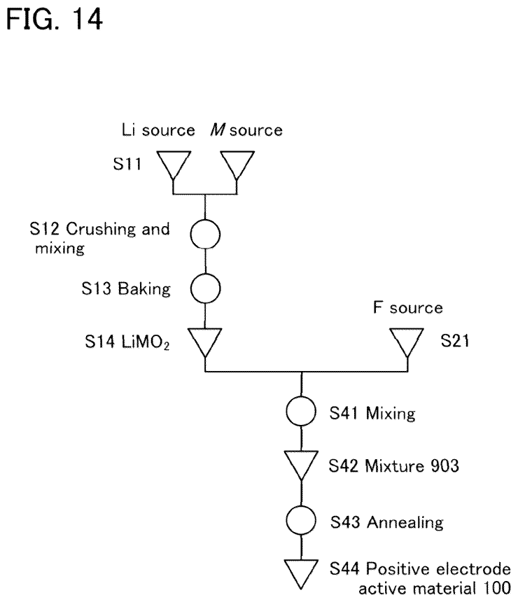

In this embodiment, examples of a method for forming the positive electrode active material 100 that is one embodiment of the present invention will be described with reference to FIG. 14 to FIG. 17.

### <Step S11>

First, in Step S11 in FIG. 14, a lithium source and a transition metal M source are prepared as materials of a composite oxide (LiMO₂) containing lithium, a transition metal M, and oxygen.

As the lithium source, for example, lithium carbonate, lithium fluoride, or the like can be used.

As mentioned in the above embodiment, a metal which together with lithium can form a composite oxide having the layered rock-salt structure belonging to the space group R-3m is preferably used as the transition metal M. For example, at least one of manganese, cobalt, and nickel can be used. Specifically, using cobalt at greater than or equal to 75 atomic %, preferably greater than or equal to 90 atomic %, further preferably greater than or equal to 95 atomic % as the transition metal M brings many advantages such as relatively easy synthesis, easy handling, and excellent cycle performance.

As the transition metal M source, oxide or hydroxide of the metal described as an example of the transition metal M, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal M source are mixed. The mixing can be performed by a dry process or a wet process. For example, a ball mill, a bead mill, or the like can be used for the mixing. When the ball mill is used, a zirconia ball is preferably used as grinding media, for example.

### <Step S13>

Next, in Step S13, the materials mixed in the above manner are heated. This step is sometimes referred to as baking or first heating to distinguish this step from a heating step performed later. The heating is preferably performed at a temperature higher than or equal to 800° C. and lower than 1100° C., further preferably at a temperature higher than or equal to 900° C. and lower than or equal to 1000° C., and still further preferably at approximately 950° C. Alternatively, the heating is preferably performed at a temperature higher than or equal to 800° C. and lower than or equal to 1000° C. Alternatively, the heating is preferably performed at a temperature higher than or equal to 900° C. and lower than or equal to 1100° C. An excessively low temperature might lead to insufficient decomposition and melting of the lithium source and the transition metal M source. An excessively high temperature, on the other hand, might cause a defect due to excessive reduction of the metal taking part in an oxidation-reduction reaction and used as the transition metal M, evaporation of lithium, or the like.

The heating time can be longer than or equal to an hour and shorter than or equal to 100 hours, for example, and is preferably longer than or equal to 2 hours and shorter than or equal to 20 hours. Alternatively, the heating time is preferably longer than or equal to an hour and shorter than or equal to 20 hours. Alternatively, the heating time is preferably longer than or equal to two hours and shorter than or equal to 100 hours. Baking is preferably performed in an atmosphere with few moisture, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature (25° C.). The temperature decreasing time from the specified temperature to room temperature is preferably longer than or equal to 10 hours and shorter than or equal to 50 hours, for example. Note that the cooling to room temperature in Step S13 is not essential. As long as later steps of Step S41 to Step S44 are performed without problems, the cooling may be performed to a temperature higher than room temperature.

### <Step S14>

Next, in Step S14, the materials baked in the above manner are collected, whereby the composite oxide (LiMO₂) containing lithium, the transition metal M, and oxygen is obtained. Specifically, lithium cobalt oxide, lithium manganese oxide, lithium nickel oxide, lithium cobalt oxide in which manganese is substituted for part of cobalt, lithium cobalt oxide in which nickel is substituted for part of cobalt, lithium nickel-manganese-cobalt oxide, or the like is obtained.

Alternatively, a composite oxide containing lithium, the transition metal M, and oxygen that is synthesized in advance may be used in Step S14. In that case, Step S11 to Step S13 can be omitted.

For example, as a composite oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the average particle diameter (D50) is approximately 6.5 μm, and the concentrations of elements other than lithium, cobalt, and oxygen are approximately equal to or less than those of C-10N in the impurity analysis by GD-MS.

In this embodiment, cobalt is used as the metal M, and lithium cobalt oxide particle synthesized in advance (CELLSEED C-10N manufactured by NIPPON CHEMICAL INDUSTRIAL CO., LTD.) is used.

### <Step S21>

Next, in Step S21, a fluorine source is prepared. Although not shown, a lithium source is preferably prepared as well.

As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃) sodium aluminum hexafluoride (Na₃AlF₆), or the like can be used. The fluorine source is not limited to a solid, and for example, fluorine (F₂), carbon fluoride, sulfur fluoride, oxygen fluoride (e.g., OF₂, O₂F₂, O₃F₂, O₄F₂, and O₂F), or the like may be used and mixed in the atmosphere in a heating step described later. A plurality of fluorine sources may be mixed to be used. Among them, lithium fluoride, which has a relatively low melting point of 848° C., is preferable because it is easily melted in an annealing process described later.

As the lithium source, for example, lithium fluoride, lithium carbonate, or the like can be used. That is, lithium fluoride can be used as both the lithium source and the fluorine source. In addition, magnesium fluoride can be used as both the fluorine source and the magnesium source.

In this embodiment, as the fluorine source and the lithium source, lithium fluoride (LiF) is prepared.

In addition, in the case where the following mixing and grinding steps are performed by a wet process, a solvent is prepared. As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetone is used.

The fluorine source is preferably sufficiently pulverized in advance. For example, the D50 (median diameter) is preferably greater than or equal to 10 nm and less than or equal to 20 μm, further preferably greater than or equal to 100 μm and less than or equal to 5 μm. Alternatively, the D50 is preferably greater than or equal to 10 nm and less than or equal to 5 μm. Alternatively, the D50 is preferably greater than or equal to 100 μm and less than or equal to 20 μm. When mixed with a composite oxide containing lithium, the transition metal M, and oxygen in the later step, the fluorine source pulverized to such a small size is easily attached to surfaces of composite oxide particles uniformly. The fluorine source is preferably attached to the surfaces of the composite oxide particles uniformly, in which case fluorine is easily distributed to the region in the vicinity of the surface of the composite oxide particles after heating.

### <Step S41>

Next, in Step S41, LiMO₂ obtained in Step S14 and the fluorine source are mixed. The atomic ratio of the transition metal M in the composite oxide containing lithium, the transition metal, and oxygen to fluorine F in the fluorine source is preferably M:F=100:y (0.1≤y≤10), further preferably M:F=100:y (0.2≤y≤5), still further preferably M:F=100:y (0.3≤y≤3).

The conditions of the mixing in Step S41 are preferably milder than those of the mixing in Step S12 in order not to damage the particles of the composite oxide. For example, conditions with a lower rotation frequency or shorter time than the mixing in Step S12 are preferable. In addition, it can be said that conditions of the dry process are less likely to break the particles than those of the wet process. For example, a ball mill, a bead mill, or the like can be used for the mixing. When the ball mill is used, a zirconia ball is preferably used as grinding media, for example.

### <Step S42>

Next, in Step S42, the materials mixed in the above manner are collected, whereby a mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through baking after addition of a fluorine source or the like to the starting material of lithium cobalt oxide may be used instead of the mixture 903 in Step S42. In that case, there is no need to separate steps Step S11 to Step S14 and steps Step S21 to Step S23, which is simple and productive.

Alternatively, lithium cobalt oxide to which fluorine is added in advance may be used. When lithium cobalt oxide to which fluorine is added is used, the process can be simpler because steps up to Step S42 can be omitted.

In addition, a fluorine source may be further added to the lithium cobalt oxide to which fluorine is added in advance.

### <Step S43>

Next, in Step S43, the mixture 903 is heated in an atmosphere containing oxygen. The heating further preferably has the adhesion preventing effect to prevent particles of the mixture 903 from adhering to one another. This step is sometimes referred to as annealing to distinguish this step from the heating step performed before.

Examples of the heating having the adhesion preventing effect are heating while the mixture 903 is being stirred and heating while a container containing the mixture 903 is being vibrated.

The heating temperature in Step S43 needs to be higher than or equal to the temperature at which a reaction between LiMO₂ and the mixture 902 proceeds. Here, the temperature at which the reaction proceeds is a temperature at which interdiffusion between elements included in LiMO₂ and the mixture 902 occurs. Thus, the heating temperature may be lower than the melting temperatures of these materials. For example, in an oxide, solid-phase diffusion occurs at a temperature that is 0.757 times (Tamman temperature T_{d}) the melting temperature Tₘ. Thus, the heating temperature is, for example, higher than or equal to 500° C., preferably higher than or equal to 830° C.

A higher annealing temperature is preferable because it facilitates the reaction, shortens the annealing time, and enables high productivity.

Note that the annealing temperature needs to be lower than or equal to a decomposition temperature of LiMO₂ (1130° C. in the case of LiCoO₂). At around the decomposition temperature, a slight amount of LiMO₂ might be decomposed. Thus, the annealing temperature is preferably lower than or equal to 1130° C., further preferably lower than or equal to 1000° C., further preferably lower than or equal to 950° C., and further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

Since lithium fluoride is lighter in weight than oxygen, when lithium fluoride vaporizes by heating, lithium fluoride in the mixture 903 decreases in some cases. Thus, at the time of heating the mixture 903, the partial pressure of fluorine or a fluoride in the atmosphere is preferably controlled to be within an appropriate range. For example, a method of putting a lid on a heating crucible is used.

The annealing is preferably performed for an appropriate time. The appropriate annealing time is changed depending on conditions, such as the annealing temperature, and the particle size and composition of LiMO₂ in Step S14. In the case where the particle size is small, the annealing is preferably performed at a lower temperature or for a shorter time than the case where the particle size is large, in some cases.

When the average particle diameter (D50) of the particles in Step S14 is approximately 12 μm, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

On the other hand, when the average particle diameter (D50) of the particles in Step S24 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

### <Step S44>

Next, in Step S44, the material annealed in the above manner is collected, whereby the positive electrode active material 100 can be formed. Here, the collected particles are preferably made to pass through a sieve. Through the sieve, adhesion between particles of the positive electrode active material 100 can be solved.

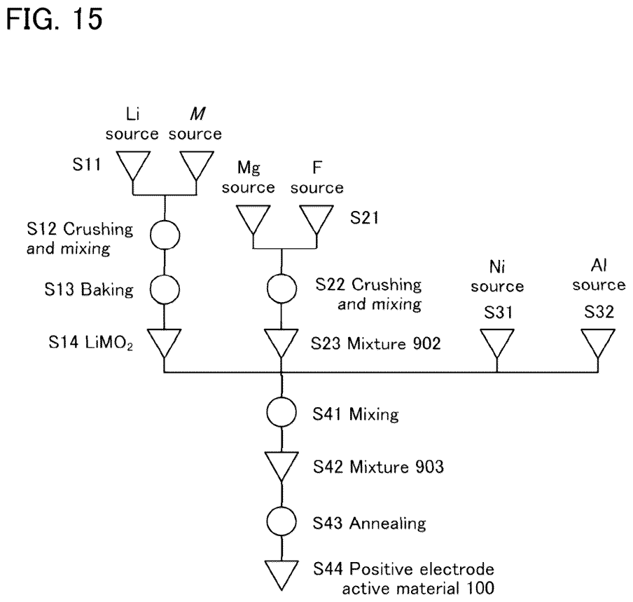

Next, examples of a formation method different from that of FIG. 14 will be described with reference to FIG. 15 to FIG. 17. Many portions are common to FIG. 14; hence, different portions will be mainly described. The description of FIG. 14 can be referred to for the common portions.

Although the formation method involving Step S41 of mixing LiMO₂ and the fluorine source has been described with reference to FIG. 14, another additive may be further mixed as in Step S21, Step S31, and Step S32 in FIG. 15 to FIG. 17.

As the additive, one or more selected from halogen except fluorine (e.g., chlorine), an alkaline earth metal (e.g., magnesium or calcium), a Group 13 element (e.g., boron, aluminum, or gallium), a Group 4 element (e.g., titanium, zirconium, or hafnium), a Group 5 element (e.g., vanadium or niobium), a Group 3 element (e.g., scandium or yttrium), lanthanoid (e.g., lanthanum, cerium, neodymium, or samarium), iron, chromium, cobalt, arsenic, zinc, silicon, sulfur, and phosphorus can be used, for example.

Examples in which a magnesium source and a fluorine source are used as additives in Step 21 and in which two kinds of additives, i.e., a nickel source in Step S31 and an aluminum source in Step S32, are used are described with reference to FIG. 15 to FIG. 17.

These additives are preferably obtained by pulverizing oxide, hydroxide, fluoride, or the like of the elements. The pulverization can be performed by wet process, for example.

For example, as the magnesium source, for example, magnesium fluoride, magnesium oxide, magnesium hydroxide, magnesium carbonate, or the like can be used. In this embodiment, magnesium fluoride (MgF₂) is prepared as the magnesium source.

In the case of using LiF as the fluorine source and MgF₂ as the magnesium source, when lithium fluoride LiF and magnesium fluoride MgF₂ are mixed at a molar ratio of approximately LiF:MgF₂=65:35, the effect of lowering the melting point becomes the highest. On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33).

### <Step S22>

In the case of mixing the other additive such as a magnesium source with the fluorine source, these are preferably mixed and crushed in Step S22. Although the mixing can be performed by a dry process or a wet process, the wet process is preferable because the materials can be ground to the smaller size. For example, a ball mill, a bead mill, or the like can be used for the mixing. When the ball mill is used, a zirconia ball is preferably used as grinding media, for example. The mixing step and the grinding step are preferably performed sufficiently to pulverize the materials.

### <Step S23>

Next, in Step S23, the materials mixed and ground in the above manner are collected. The mixture here is referred to as the mixture 902.

As shown in FIG. 15, the nickel source and the aluminum source can be mixed at the same time as the mixture 902 is mixed in Step S42. This method is preferable for high productivity since the number of annealing times is small.

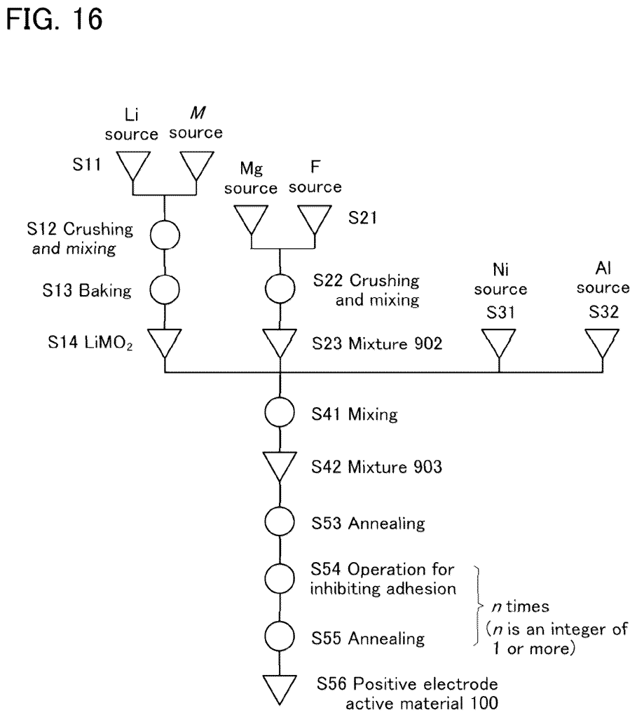

As shown in FIG. 16, annealing may be performed a plurality of times in Step S53 and Step S55, between which Step S54 of operation for inhibiting adhesion may be performed. For the annealing conditions of Step S53 and Step S55, the description of Step S43 can be referred to. Examples of the operation for inhibiting adhesion include crushing with a pestle, mixing with a ball mill, mixing with a planetary centrifugal mixer, making the mixture pass through a sieve, and vibrating a container containing the composite oxide.

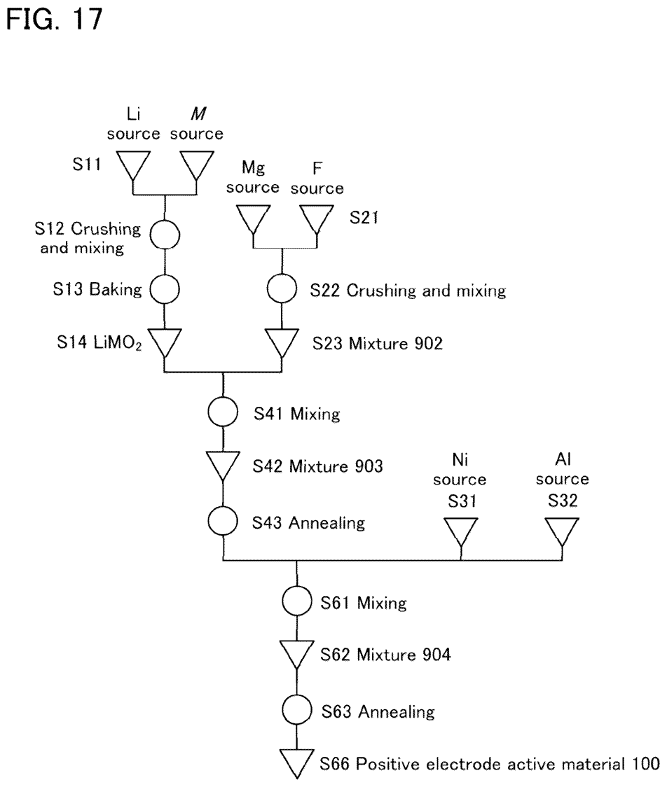

As shown in FIG. 17, LiMO₂ and the mixture 902 are mixed in Step S41 and annealed, and after that a nickel source and an aluminum source may be mixed in Step S61. The mixture here is referred to as a mixture 904. The mixture 904 is annealed again in Step S63. For the annealing conditions, the description of Step S43 can be referred to.

When the step of introducing the transition metal M and the step of introducing the additive are separately performed in such a manner, the profiles in the depth direction of the elements can be made different from each other in some cases. For example, the concentration of an additive can be made higher in the region in the vicinity of the surface than in the inner portion region of the particle. Furthermore, with the number of atoms of the transition metal M as a reference, the ratio of the number of atoms of the additive element with respect to the reference can be higher in the region in the vicinity of the surface than in the inner portion region.

This embodiment can be used in combination with the other embodiments.

### Embodiment 3

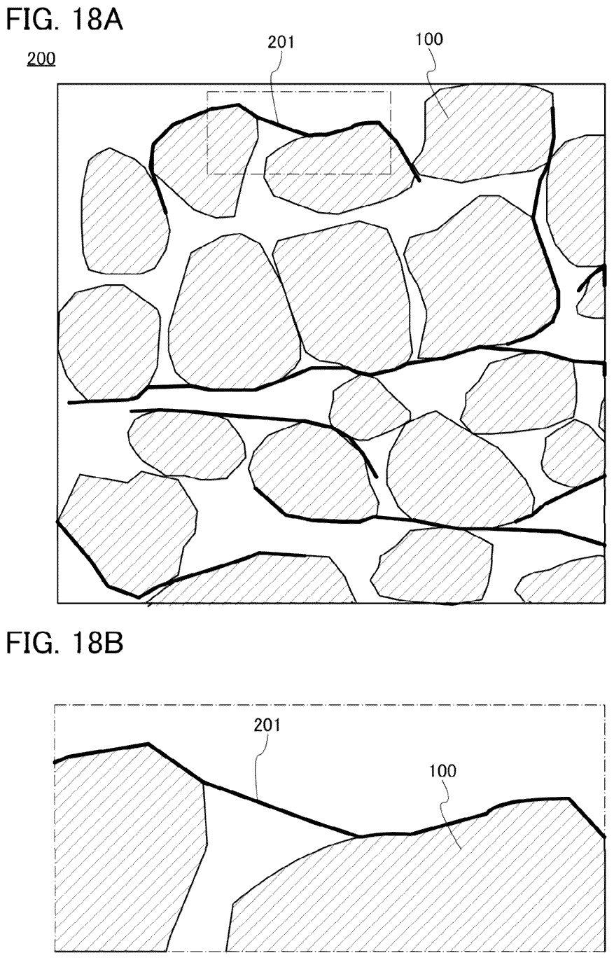

In this embodiment, examples of a secondary battery of one embodiment of the present invention are described with reference to FIG. 18 to FIG. 21.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material 100 formed by the formation method described in the above embodiments is used.

The positive electrode active material 100 described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiN₁₋ₓMₓO₂ (0<x<1) (M=Co, Al, or the like) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide is measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing graphene or a graphene compound as a conductive material is described below.

FIG. 18A is a longitudinal cross-sectional view of the active material layer 200. The active material layer 200 includes particles of the positive electrode active material 100, graphene or a graphene compound 201 serving as the conductive material, and a binder (not illustrated).

The graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself but may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

The longitudinal cross section of the active material layer 200 in FIG. 18B shows substantially uniform dispersion of the sheet-like graphene or the graphene compound 201 in the active material layer 200. The graphene or the graphene compound 201 is schematically shown by the thick line in FIG. 18B but is actually a thin film having a thickness corresponding to the thickness of a single layer or a multi-layer of carbon molecules. A plurality of sheets of graphene or the plurality of graphene compounds 201 are formed to partly coat or adhere to the surfaces of the plurality of particles of the positive electrode active material 100, so that the plurality of sheets of graphene or the plurality of graphene compounds 201 make surface contact with the particles of the positive electrode active material 100. Note that the graphene or the graphene compound 201 preferably clings to at least part of the active material. Alternatively, the graphene or the graphene compound 201 preferably overlays at least part of the active material. Alternatively, the shape of the graphene or the graphene compound 201 preferably conforms to at least part of the shape of the active material. The shape of the active material means, for example, unevenness of a single active material particle or unevenness formed by a plurality of active material particles. The graphene or the graphene compound 201 preferably surrounds at least part of the active material. The graphene or the graphene compound 201 may have a hole.

Here, the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the charge and discharge capacity of the secondary battery can be increased.

Here, it is preferable to perform reduction after a layer to be the active material layer 200 is formed in such a manner that graphene oxide is used as the graphene or the graphene compound 201 and mixed with an active material. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene or the graphene compound 201 is capable of making low-resistance surface contact; accordingly, the electrical conduction between the particles of the positive electrode active material 100 and the graphene or the graphene compound 201 can be improved with a small amount of the graphene and the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating film to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### <Negative Electrode Active Material>

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (Mis Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### <Negative Electrode Current Collector>

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a secondary battery from exploding or catching fire even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and a spacer are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer is described below as another structure example of a secondary battery.

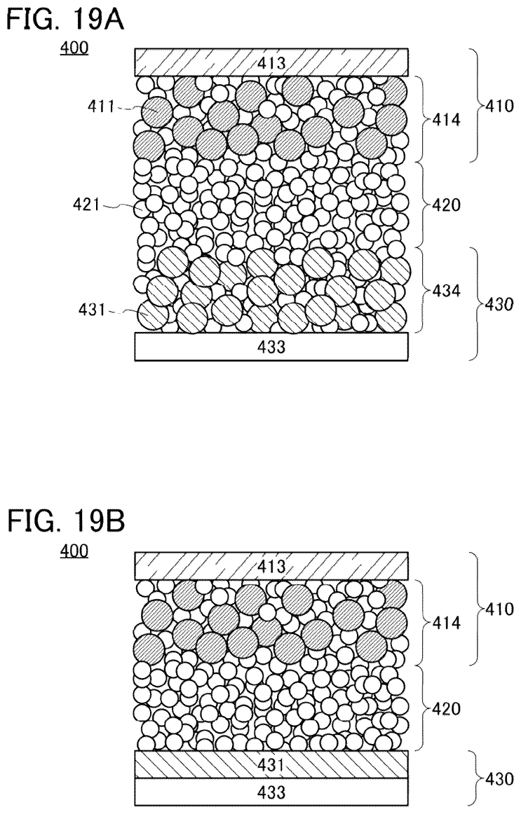

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, it is possible that the negative electrode 430 does not include the solid electrolyte 421 as illustrated in FIG. 19B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-X}Li₃ₓTiO₃), a material with a NASICON crystal structure (e.g., Li₁₋ₓAl_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAl Ti₂₋ₓ(PO₄)₃ (0≤x≤1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

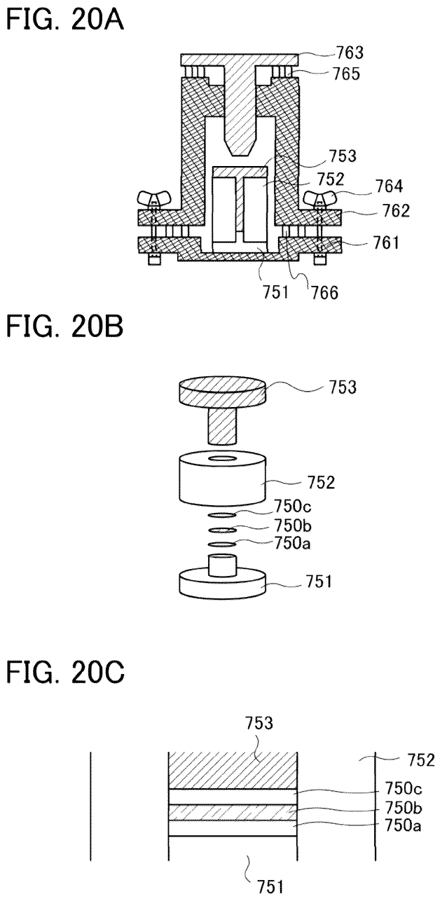

FIG. 20 shows an example of a cell for evaluating materials of an all-solid-state battery.

FIG. 20A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763. The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 20C. Note that the same portions in FIG. 20A, FIG. 20B, and FIG. (C) are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

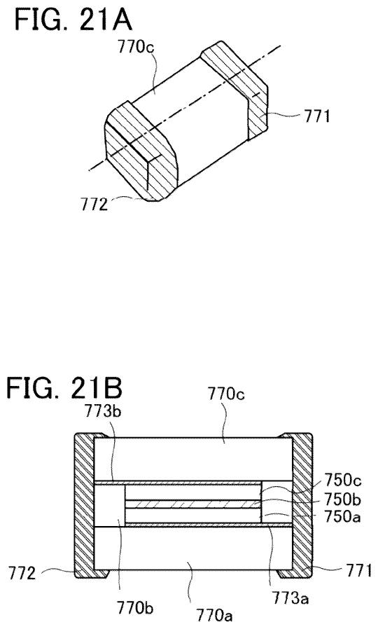

FIG. 21A is a perspective view of a secondary battery of one embodiment of the present invention that has an exterior body and a shape different from those in FIG. 20. The secondary battery in FIG. 21A includes external electrodes 771 and 772 and is sealed with an exterior body including a plurality of package components.

FIG. 21B illustrates an example of a cross section along the dashed-dotted line in FIG. 21A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 4

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

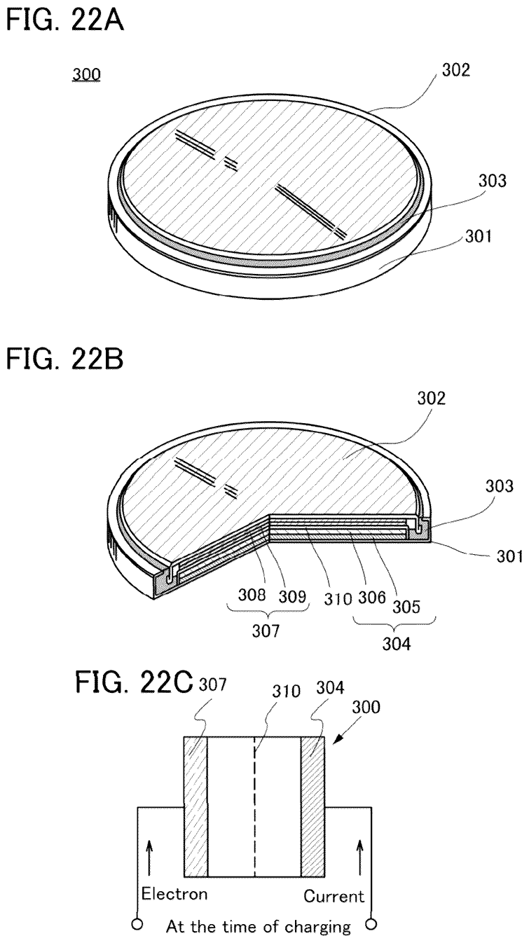

First, an example of a coin-type secondary battery is described. FIG. 22A is an external view of a coin-type (single-layer flat type) secondary battery, and FIG. 22B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 22B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 22C. When a secondary battery using lithium is regarded as a closed circuit, movement of lithium ions and the current flow are in the same direction. Note that in the secondary battery using lithium, the anode and the cathode interchange in charging and discharging, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals illustrated in FIG. 22C are connected to a charger, and the secondary battery 300 is charged. As the charge of the secondary battery 300 proceeds, a potential difference between electrodes increases.

### <Cylindrical Secondary Battery>

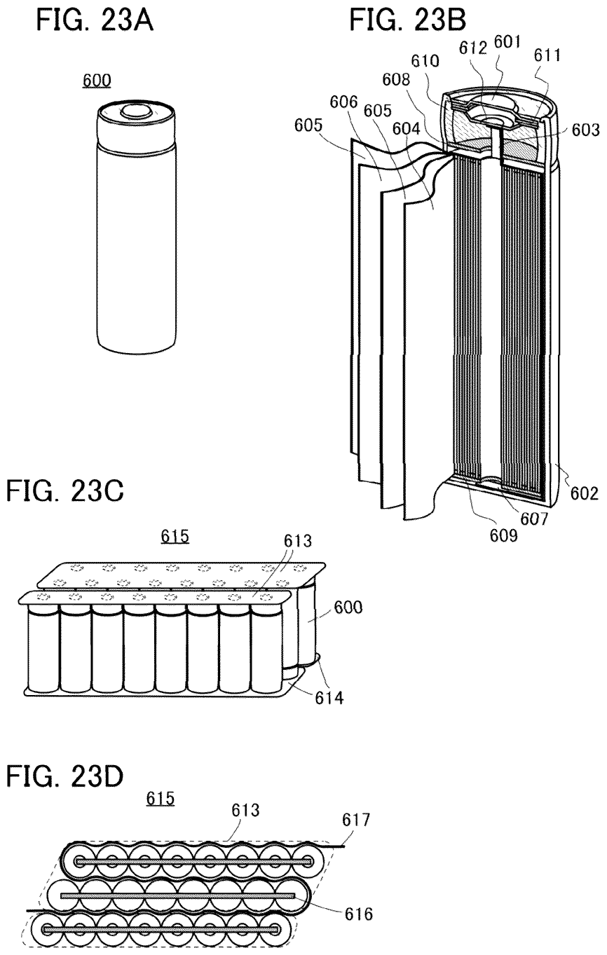

Next, an example of a cylindrical secondary battery is described with reference to FIG. 23. FIG. 23A shows an external view of a cylindrical secondary battery 600. FIG. 23B is a schematic cross-sectional view of the cylindrical secondary battery 600. The cylindrical secondary battery 600 includes, as illustrated in FIG. 23B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 23C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 23D is a top view of the module 615. The conductive plate 613 is shown by a dotted line for clarity of the diagram. As illustrated in FIG. 23D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge and discharge capacity and excellent cycle performance can be obtained.

### <Structure Examples of Secondary Battery>

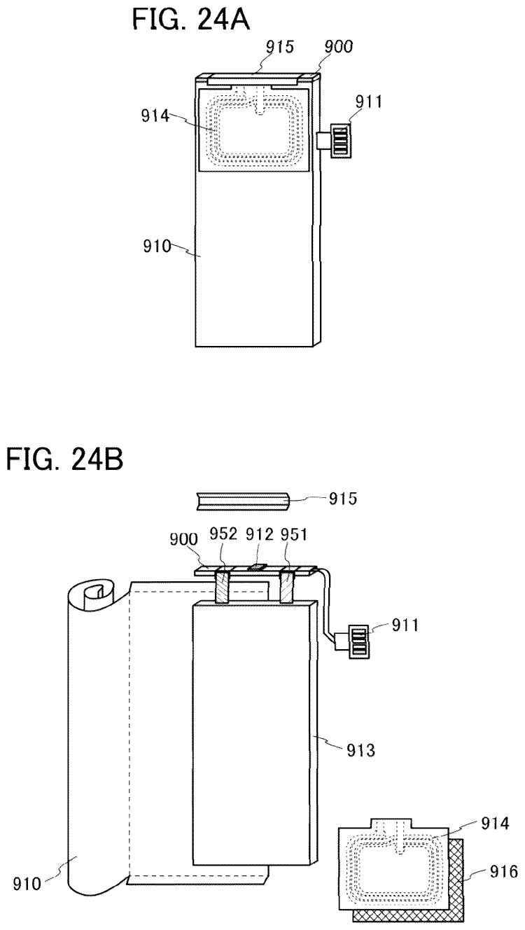

Other structure examples of secondary batteries are described with reference to FIG. 24 to FIG. 28.

FIG. 24A and FIG. 24B are external views of a battery pack. The battery pack includes a secondary battery 913 and a circuit board 900. A secondary battery 913 is connected to an antenna 914 through a circuit board 900. A label 910 is attached to the secondary battery 913. In addition, as illustrated in FIG. 24B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 24.

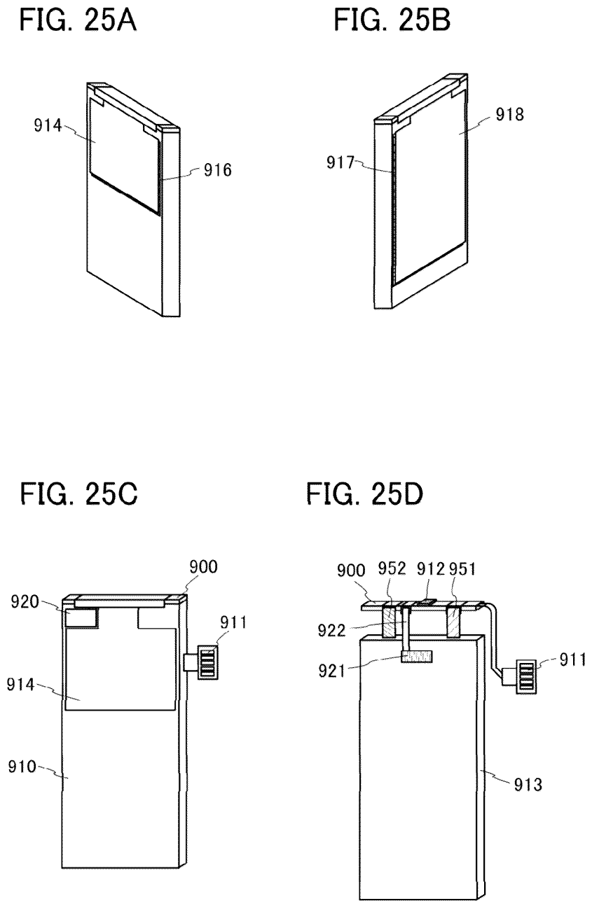

For example, as illustrated in FIG. 25A and FIG. 25B, two opposite surfaces of the secondary battery 913 illustrated in FIG. 24A and FIG. 24B may be provided with respective antennas. FIG. 25A is an external view seen from one side of the opposite surfaces, and FIG. 25B is an external view seen from the other side of the opposite surfaces. Note that for portions similar to those of the secondary battery illustrated in FIG. 24A and FIG. 24B, the description of the secondary battery illustrated in FIG. 24A and FIG. 24B can be appropriately referred to.

As illustrated in FIG. 25A, the antenna 914 is provided on one of the opposite surfaces of the secondary battery 913 with the layer 916 located therebetween, and as illustrated in FIG. 25B, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 25C, the secondary battery 913 illustrated in FIG. 24A and FIG. 24B may be provided with a display device 920. The display device 920 is electrically connected to the terminal 911. Note that the label 910 is not necessarily provided in a portion where the display device 920 is provided. Note that for portions similar to those of the secondary battery illustrated in FIG. 24A and FIG. 24B, the description of the secondary battery illustrated in FIG. 24A and FIG. 24B can be appropriately referred to.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 25D, the secondary battery 913 illustrated in FIG. 24A and FIG. 24B may be provided with a sensor 921. The sensor 921 is electrically connected to the terminal 911 via a terminal 922. Note that for portions similar to those of the secondary battery illustrated in FIG. 24A and FIG. 24B, the description of the secondary battery illustrated in FIG. 24A and FIG. 24B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

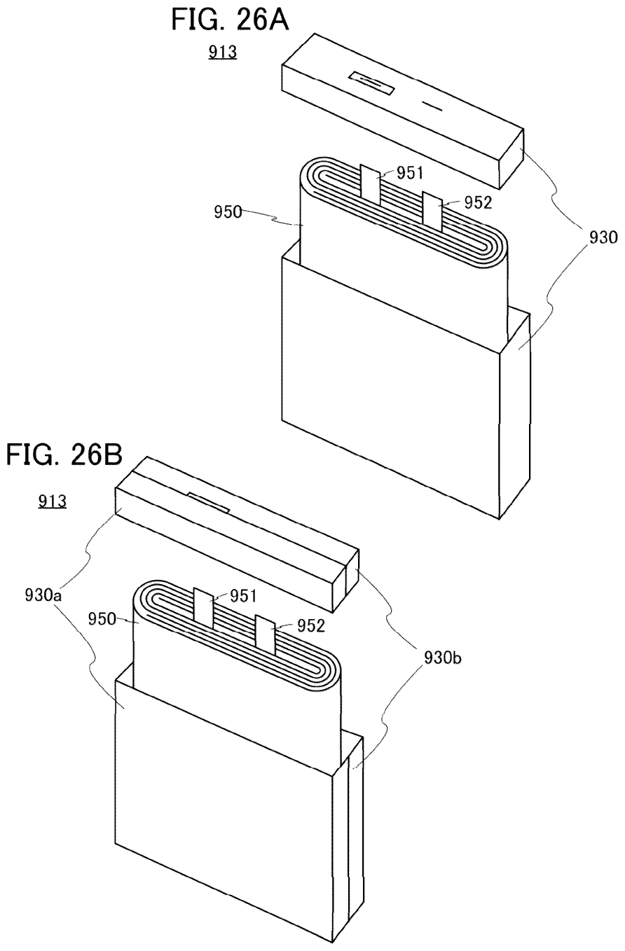

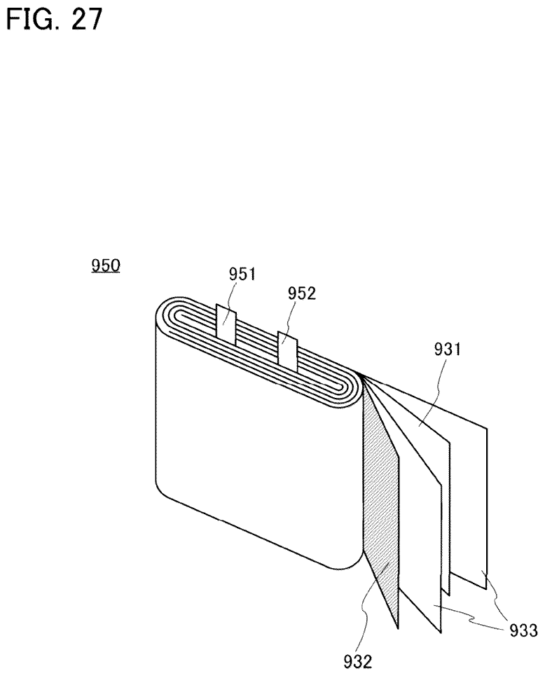

Furthermore, structure examples of the secondary battery 913 are described with reference to FIG. 26 and FIG. 27.

The secondary battery 913 illustrated in FIG. 26A includes a wound body 950 provided with the terminal 951 and the terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 26A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 26B, the housing 930 illustrated in FIG. 26A may be formed using a plurality of materials. For example, in the secondary battery 913 illustrated in FIG. 26B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 27 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 24 via one of the terminal 951 and the terminal 952. The positive electrode 932 is connected to the terminal 911 illustrated in FIG. 24 via the other of the terminal 951 and the terminal 952.

When the positive electrode active material described in the above embodiment is used in the positive electrode 932, the secondary battery 913 with high charge and discharge capacity and excellent cycle performance can be obtained.

### <Laminated Secondary Battery>

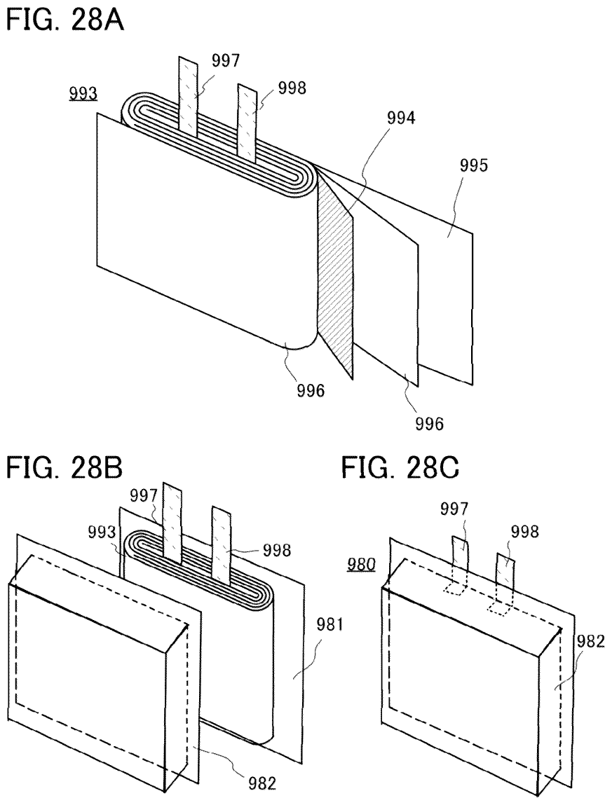

Next, an example of a laminated secondary battery is described with reference to FIG. 28 to FIG. 32. When the laminated secondary battery has flexibility and is used in an electronic device at least part of which is flexible, the secondary battery can be bent as the electronic device is bent.

A laminated secondary battery 980 is described with reference to FIG. 28. The laminated secondary battery 980 includes a wound body 993 illustrated in FIG. 28A. The wound body 993 includes a negative electrode 994, a positive electrode 995, and separators 996. The wound body 993 is, like the wound body 950 illustrated in FIG. 27, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 28B, the above-described wound body 993 is packed in a space formed by bonding a film 981 and a film 982 having a depressed portion that serve as exterior bodies by thermocompression bonding or the like, whereby the secondary battery 980 as illustrated in FIG. 28C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 28B and FIG. 28C show an example of using two films, the wound body 993 may be placed in a space formed by bending one film.

When the positive electrode active material described in the above embodiment is used in the positive electrode 995, the secondary battery 980 with high charge and discharge capacity and excellent cycle performance can be obtained.

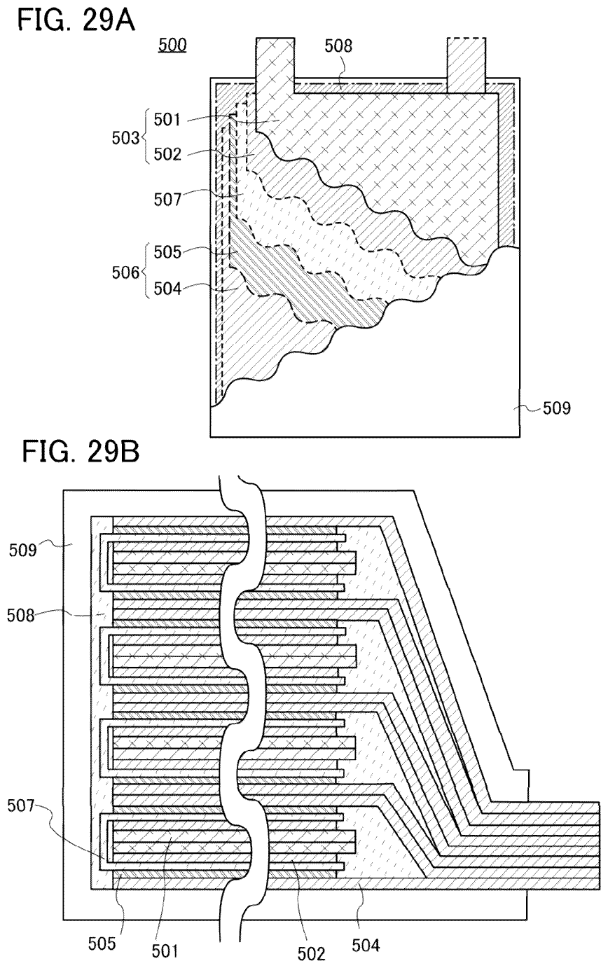

In FIG. 28, an example in which the secondary battery 980 includes a wound body in a space formed by films serving as exterior bodies is described; however, as illustrated in FIG. 29, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 29A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 29A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 29B shows an example of a cross-sectional structure of the laminated secondary battery 500. FIG. 29A shows an example in which only two current collectors are included for simplicity, but actually, a plurality of electrode layers are included as illustrated in FIG. 29B.

In FIG. 29B, the number of electrode layers is 16, for example. Note that the secondary battery 500 has flexibility even though the number of electrode layers is set to 16. FIG. 29B illustrates a structure including 8 layers of negative electrode current collectors 504 and 8 layers of positive electrode current collectors 501, i.e., 16 layers in total. Note that FIG. 29B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge and discharge capacity. In contrast, with a small number of electrode layers, the secondary battery can have small thickness and high flexibility.

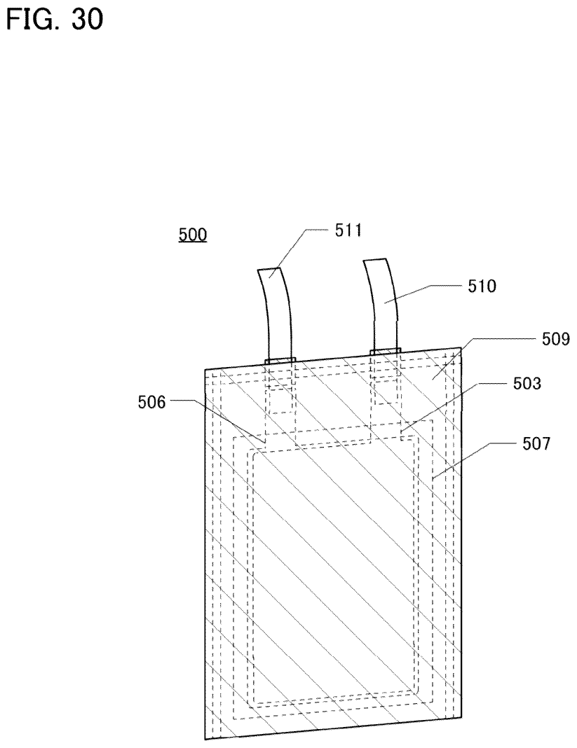

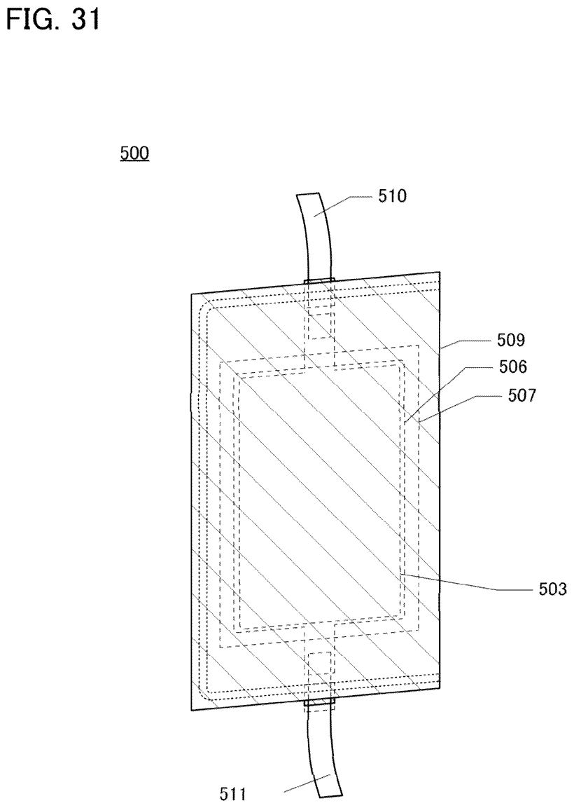

FIG. 30 and FIG. 31 each show an example of the external view of the laminated secondary battery 500. In FIG. 30 and FIG. 31, the positive electrode 503, the negative electrode 506, the separator 507, the exterior body 509, a positive electrode lead electrode 510, and a negative electrode lead electrode 511 are included.

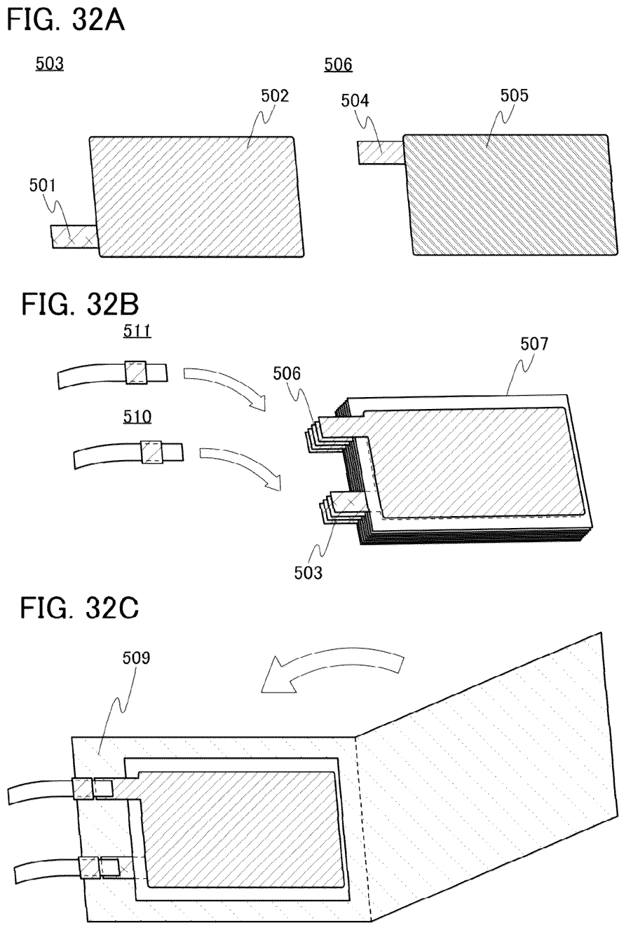

FIG. 32A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 32A.

### <Method for Manufacturing Laminated Secondary Battery>

Here, an example of a method for manufacturing the laminated secondary battery whose external view is illustrated in FIG. 30 is described with reference to FIG. 32B and FIG. 32C.

First, the negative electrode 506, the separator 507, and the positive electrode 503 are stacked. FIG. 32B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 32C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be manufactured.

When the positive electrode active material described in the above embodiment is used in the positive electrode 503, the secondary battery 500 with high charge and discharge capacity and excellent cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be suppressed, and the reliability of the all-solid-state battery can be improved.

This embodiment can be implemented in appropriate combination with any of the other embodiments.

### Embodiment 5

In this embodiment, examples of electronic devices each including the secondary battery of one embodiment of the present invention are described.

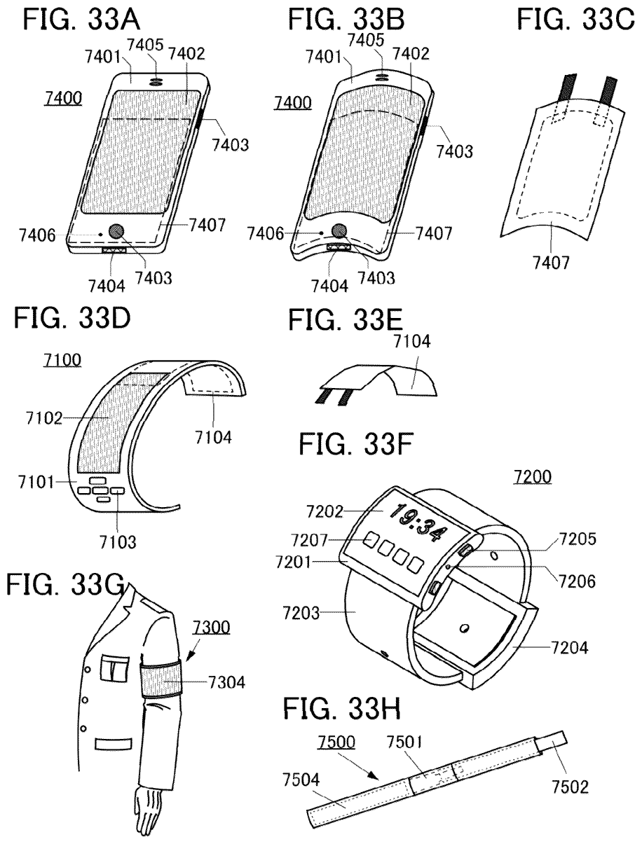

First, FIG. 33A to FIG. 33G show examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house or a building or a curved interior/exterior surface of an automobile.

FIG. 33A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 33B illustrates the mobile phone 7400 that is curved. When the whole mobile phone 7400 is curved by external force, the secondary battery 7407 provided therein is also curved. FIG. 33C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 33D shows an example of a bangle display device. A portable display device 7100 includes a housing 7101, a display portion 7102, operation buttons 7103, and a secondary battery 7104. FIG. 33E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the inverse of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 33F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 33E that is in the state of being curved can be provided in the housing 7201. Alternatively, the secondary battery 7104 illustrated in FIG. 33E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 33G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

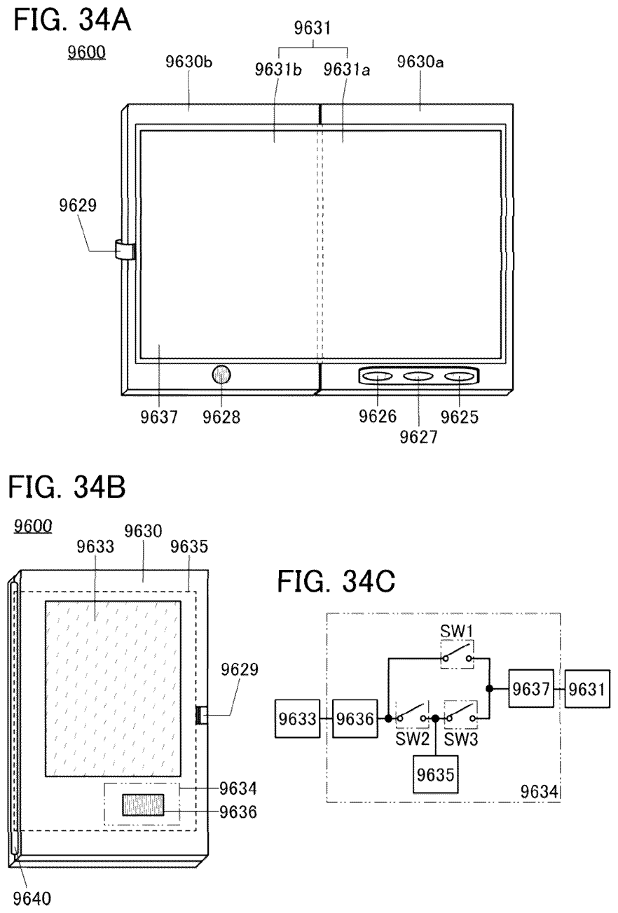

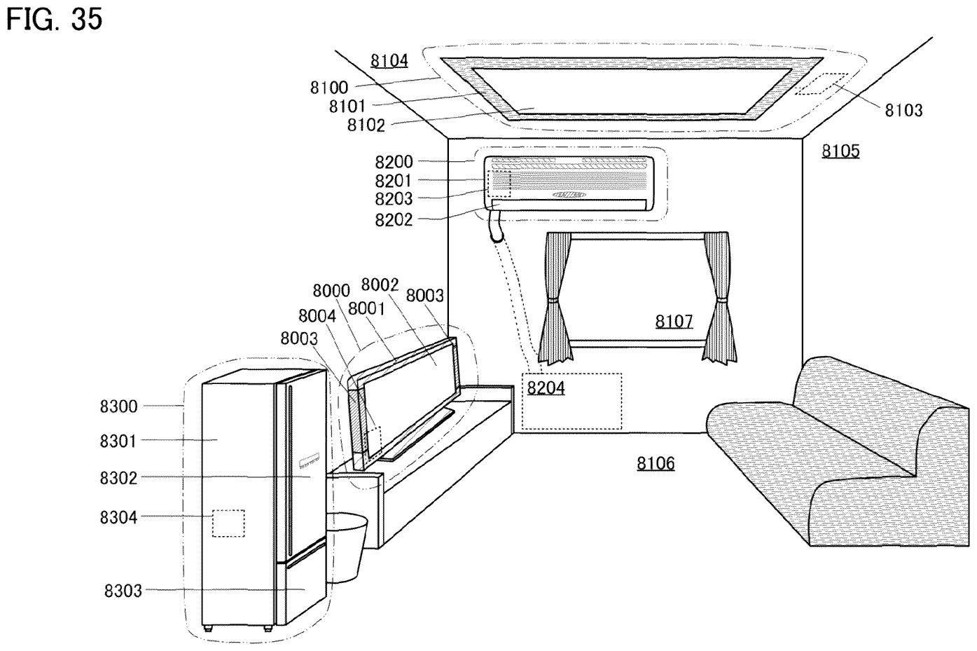

Examples of electronic devices each including the secondary battery with excellent cycle performance described in the above embodiment are described with reference to FIG. 33H, FIG. 34, and FIG. 35.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge and discharge capacity are desired in consideration of handling ease for users.

FIG. 33H is a perspective view of a device called a cigarette smoking device (electronic cigarette). In FIG. 33H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 illustrated in FIG. 33H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

Next, FIG. 34A and FIG. 34B show an example of a tablet terminal that can be folded in half. A tablet terminal 9600 illustrated in FIG. 34A and FIG. 34B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 34A illustrates the tablet terminal 9600 that is opened, and FIG. 34B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631. Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 34A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-resolution images than the other.

The tablet terminal 9600 is folded in half in FIG. 34B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 that can be used for a long time over a long period can be provided.

The tablet terminal 9600 illustrated in FIG. 34A and FIG. 34B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 34B are described with reference to a block diagram in FIG. 34C. The solar cell 9633, the power storage unit 9635, the DCDC converter 9636, a converter 9637, switches SW1 to SW3, and the display portion 9631 are illustrated in FIG. 34C, and the power storage unit 9635, the DCDC converter 9636, the converter 9637, and the switches SW1 to SW3 correspond to the charge and discharge control circuit 9634 illustrated in FIG. 34B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 35 illustrates other examples of electronic devices. In FIG. 35, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 35, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 35 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 35 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 35, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 35 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 35 as an example, the secondary battery of one embodiment of the present invention can be used in an air conditioner in which the function of an indoor unit and the function of an outdoor unit are integrated in one housing.

In FIG. 35, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 35. The electric refrigerator-freezer 8300 can be supplied with electric power from a commercial power supply and can use electric power stored in the secondary battery 8304.

Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high charge and discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 6

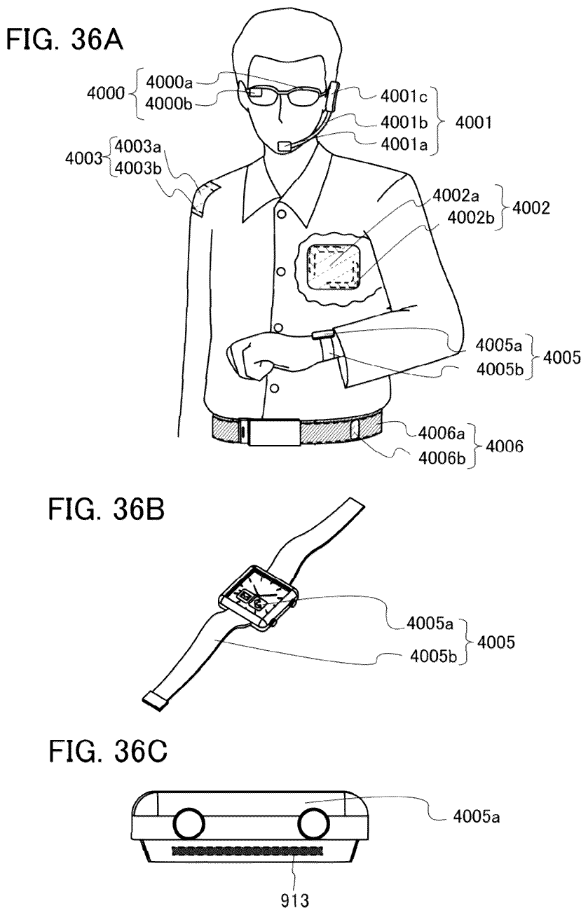

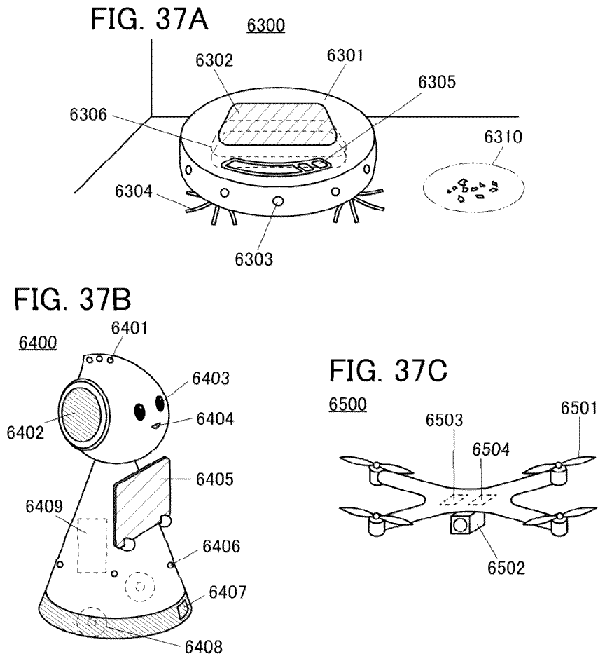

In this embodiment, examples of electronic devices each including the secondary battery described in the above embodiment are described with reference to FIG. 36 to FIG. 37.

FIG. 36A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 36A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 36B is a perspective view of the watch-type device 4005 that is detached from an arm.

FIG. 36C is a side view. FIG. 36C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 37A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 37B illustrates an example of a robot. A robot 6400 illustrated in FIG. 37B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 37C illustrates an example of a flying object. A flying object 6500 illustrated in FIG. 37C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 7

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

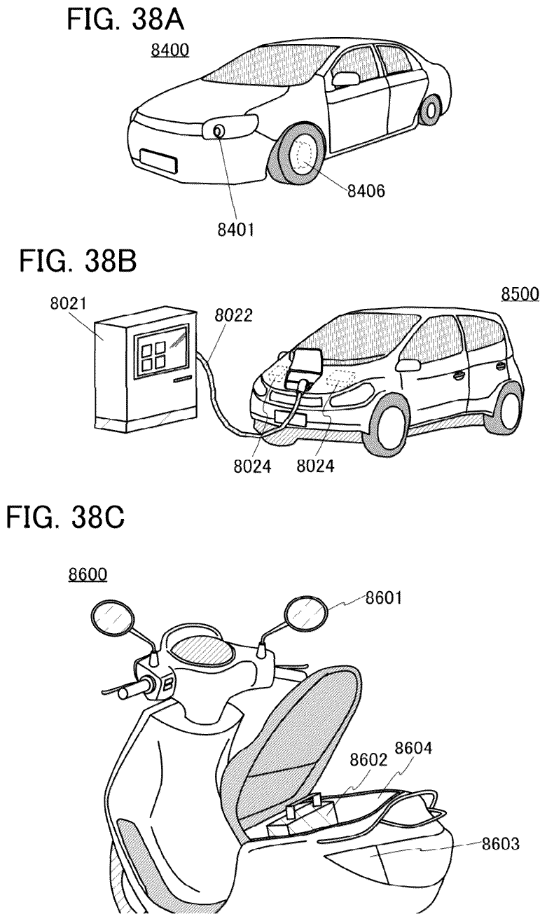

FIG. 38 illustrates examples of a vehicle including the secondary battery of one embodiment of the present invention. An automobile 8400 illustrated in FIG. 38A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 23C and FIG. 23D may be arranged to be used in a floor portion in the automobile. Alternatively, a battery pack in which a plurality of secondary batteries illustrated in FIG. 26 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 38B can be charged when the secondary battery included in the automobile 8500 is supplied with electric power through external charge equipment by a plug-in system, a contactless power feeding system, or the like. FIG. 38B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 38C illustrates an example of a motorcycle including the secondary battery of one embodiment of the present invention. A motor scooter 8600 illustrated in FIG. 38C includes a secondary battery 8602, side mirrors 8601, and direction indicators 8603. The secondary battery 8602 can supply electric power to the direction indicators 8603.

In the motor scooter 8600 shown in FIG. 38C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge and discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Example

In this example, a positive electrode active material of one embodiment of the present invention was formed, and its magnetism was analyzed. Using the positive electrode active material, a secondary battery was fabricated, and the characteristics were evaluated.

### <Formation of Positive Electrode Active Material>

Samples formed in this example are described with reference to the formation method illustrated in FIG. 14.

As LiMO₂ in Step S14, with the use of cobalt as the transition metal M, commercially available lithium cobalt oxide (Cellseed C-10N produced by NIPPON CHEMICAL INDUSTRIAL CO., LTD.) not containing any additive was prepared. As the fluorine source in Step S21, lithium fluoride was prepared. In Step S41 and Step S42, lithium cobalt oxide and lithium fluoride were mixed by a solid-phase method. At this time, mixing was performed such that the molecular weight of lithium fluoride was 0.5 or 1.7 when the number of cobalt atoms was regarded as 100. The mixture here is the mixture 903.

Next, in Step S43, the mixture 903 was annealed. In an alumina crucible, approximately 1.5 g to 2 g of the mixture 903 was placed, a lid was put on the crucible, and heating was performed in a muffle furnace. The atmosphere was an oxygen atmosphere with an oxygen flow rate of 10 L/min. The annealing temperature was 850° C., and the annealing time was 20 hours or 60 hours.

As a comparative example 1, lithium cobalt oxide annealed without addition of lithium fluoride was prepared. As a comparative example 2 and a comparative example 3, mixtures of lithium cobalt oxide and lithium fluoride which were not subjected to annealing were prepared.

The formation conditions are shown in Table 6.

TABLE 6

| | Mixing conditions | Annealing |
|---|---|---|
| Sample 1 | LiCoO₂ | 850° C., 60 hr |
| (Comparative example) | | |
| Sample 2 | LiCoO₂ + 0.5 wt % LiF | — |
| (Comparative example) | | |
| Sample 3 | LiCoO₂ + 1.7 wt % LiF | — |
| (Comparative example) | | |
| Sample 4 | LiCoO₂ + 0.5 wt % LiF | 850° C., 60 hr |
| Sample 5 | LiCoO₂ + 0.5 wt % LiF | 850° C., 20 hr |
| Sample 6 | LiCoO₂ + 1.7 wt % LiF | 850° C., 60 hr |

### <ESR>

The positive electrode active materials formed in the above-described manner were analyzed by ESR. With an electron spin resonance spectrometer JES-FA300 manufactured by JEOL Ltd., measurement was performed under normal atmospheric pressure by putting the samples in the powder state in a quartz tube with an outside diameter φ of 5 mm. The sample amount was 5 mg each. Each of the samples was measured at 300 K, 250 K, 200 K, 150 K, and 113 K. At this time, the Q value was more than or equal to 1.0×10⁴ in all the measurements.

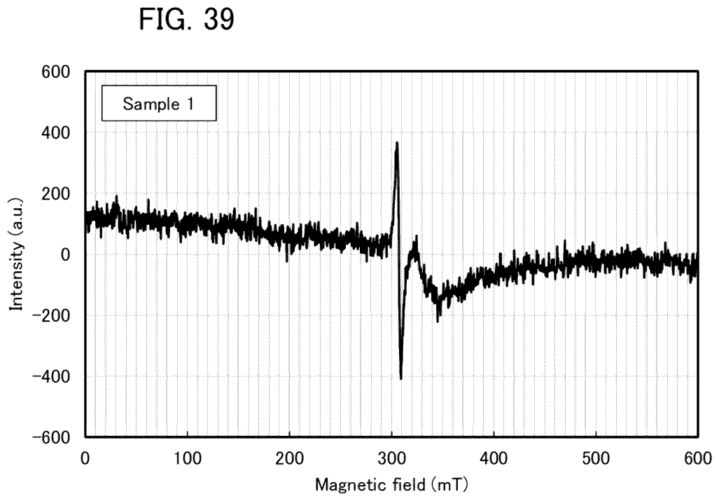

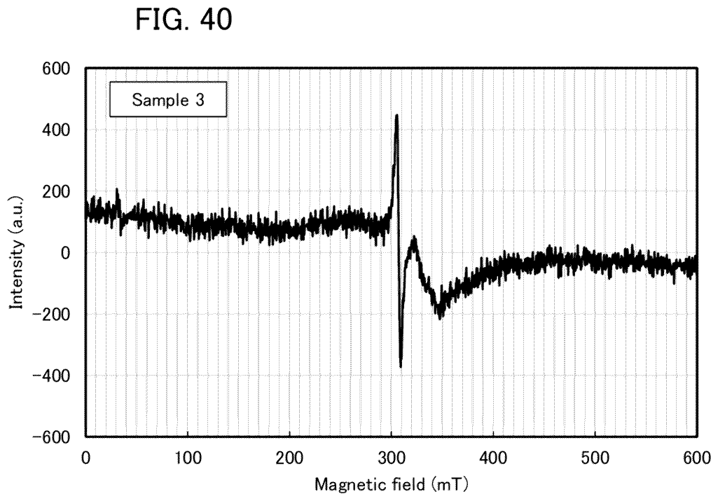

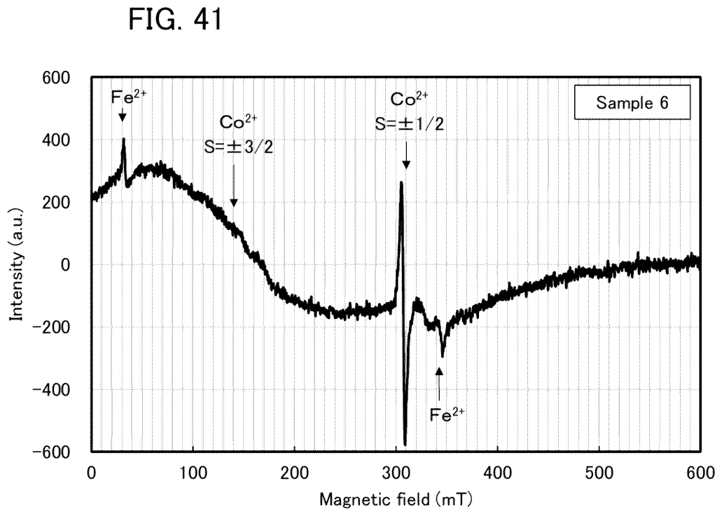

As an example of the measurement results, FIG. 39, FIG. 40, and FIG. 41 show ESR spectra at 300 K of Sample 1, Sample 3, and Sample 6, respectively. It is known that a signal derived from Co²⁺ or Co⁴⁺ in lithium cobalt oxide appears at g-around 2. A signal centering g=2.14 or 307 mT with a Δ Peak-to Peak of 4 mT, that is, a signal in which peaks are observed at 305 mT and 309 mT, is derived from S=±1/2 spin of cobalt ions.

Signals observed at around 33 mT and around 340 mT are derived from impurity Fe²⁺ according to Non-Patent Document 1.

In addition, a weak signal centering 153 mT or g=around 4.3 with a Δ Peak-to Peak of 176 mT observed in FIG. 40 is derived from S=+3/2 of cobalt ions.

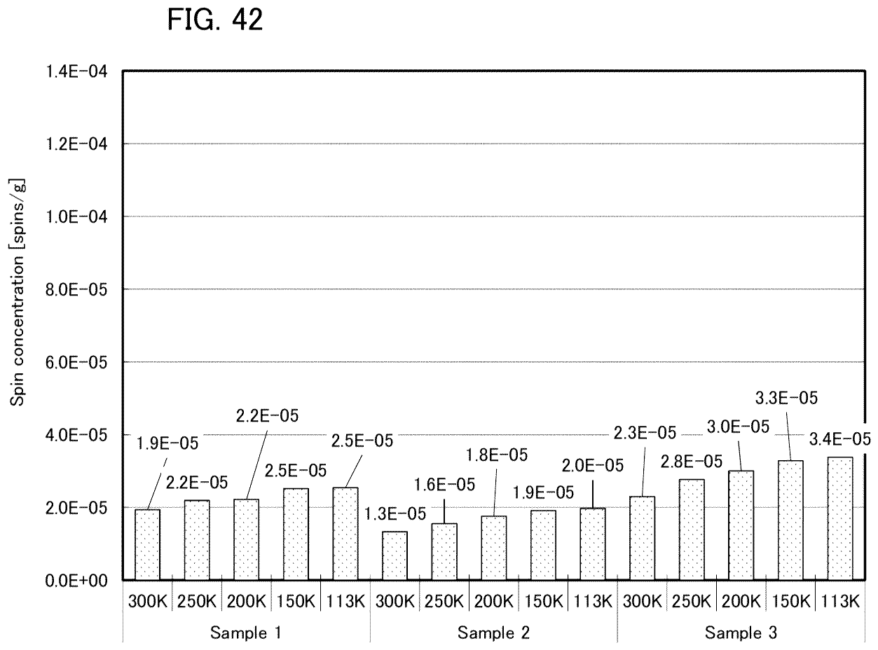

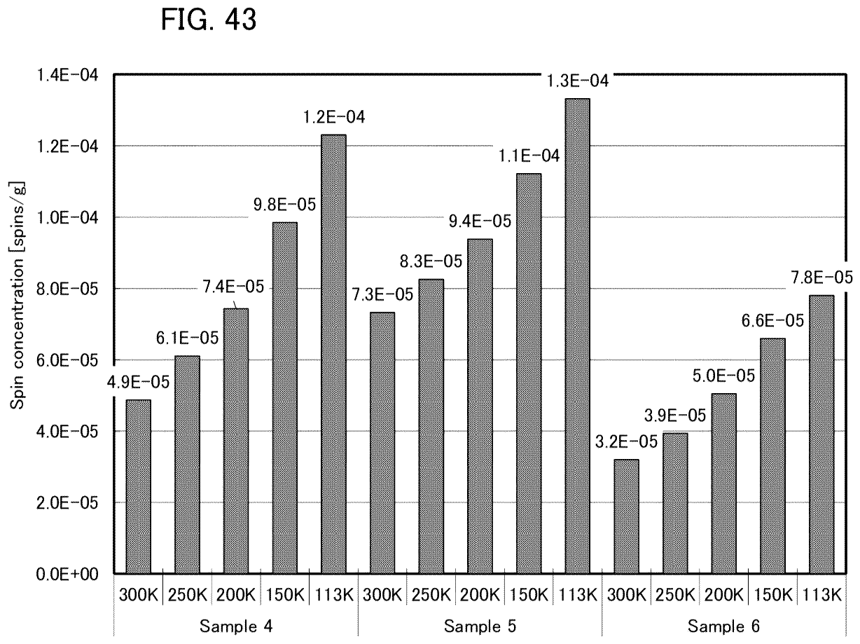

FIG. 42 and FIG. 43 show the spin concentration per positive electrode active material weight in a range from 295 mT to 318.5 mT with a microwave of 9.22 GHz, or from 2.068 to 2.233 when represented in g value (g=approximately 2.14). The integral values of the signals of cobalt ions shown in FIG. 39 to FIG. 41 are shown in FIG. 42 and FIG. 43. FIG. 42 shows the spin concentrations of Sample 1 to Sample 3 that are the comparative examples, and FIG. 43 shows those of Sample 4 to Sample 6 that are each one embodiment of the present invention.

Sample 1 to Sample 3 had no significant change in spin concentration with the temperature change, and the difference in spin concentration between 300 K and 113 K was less than or equal to 1.1×10⁻⁵ spins/g. Thus, the most part of Sample 1 to Sample 3 has a diamagnetic property. In other words, cobalt contained in Sample 1 to Sample 3 is mostly Co⁺³ with six coordinating atoms, and the samples are mostly LiCoO₂ having the layered rock-salt crystal structure.

In contrast, Sample 4 to Sample 6 had increasing spin concentrations with decreasing temperatures, and the difference in spin concentration between 300 K and 113 K was more than or equal to 2.0×10⁻⁵ spins/g, more specifically, more than or equal to 4.0×10⁻⁵ spins/g. Thus, Sample 4 to Sample 6 exhibit a paramagnetic property. In other words, part of cobalt contained in Sample 4 to Sample 6 is Co⁺² with six coordinating atoms. In consideration of the addition of lithium fluoride as well, it is probable that LiCoO₂₋ₓFₓ (0.01≤x≤1) is partly contained and a bond of cobalt and fluorine is included. From the formation process, much LiCoO₂₋ₓFₓ (0.01≤x≤1) existing in the surface portion is expected.

More specifically, the difference in spin concentration between the temperature 300 K and the temperature 113 K was 0.6×10⁻⁵ spins/g (6.0×10−6 spins/g) in Sample 1, 0.7×10⁻⁵ spins/g (7.0×10⁻⁶ spins/g) in Sample 2, 1.1×10⁻⁵ spins/g in Sample 3, 7.1×10⁻⁵ spins/g in Sample 4, 5.7×10⁻⁵ spins/g in Sample 5, and 4.6×10⁻⁵ spins/g in Sample 6.

### <Inverse of Temperature and Number of Spins>

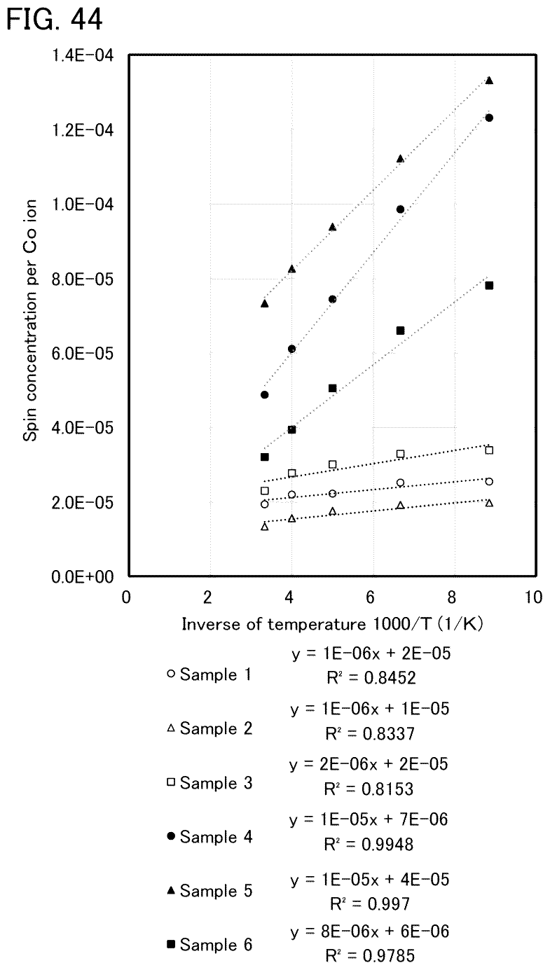

FIG. 44 is a graph of the inverse of the temperature and the spin concentration per cobalt ion plotting the above-described ESR measurement results at 300 K to 113 K. Each series of samples has the measured values at 300 K, 250 K, 200 K, 150 K, and 113 K, and the approximate straight lines, the mathematical expressions, and the R² values are shown together.

As shown in FIG. 44, the approximate straight lines of Sample 1 to Sample 3 have small slopes, which shows that Sample 1 to Sample 3 have a diamagnetic property. The slopes of the approximate straight lines of Sample 1 to Sample 3 were less than or equal to 2×10−6. Furthermore, Sample 1 to Sample 3 had R² of more than or equal to 0.8 and less than or equal to 0.85, which were lower values than those of Sample 4 to Sample 6 although having a strong correlation.

In contrast, the slopes of the approximate straight lines of Sample 4 to Sample 6 are large, which also shows Sample 4 to Sample 6 having a paramagnetic property. The slopes of the approximate straight lines of Sample 4 to Sample 6 were more than or equal to 5×10⁻⁶, more specifically, more than or equal to 8×10⁻⁶. The slopes of linear approximation of Sample 4 to Sample 6 were all less than or equal to 4×10⁻⁵. Sample 4 to Sample 6 had R² of 0.97 or more, exhibiting almost linear shapes and behaviors adhering to the Curie law.

The above ESR analysis confirmed that lithium cobalt oxide and the mixtures of lithium cobalt oxide and lithium fluoride not subjected to annealing exhibited a diamagnetic property. From the ESR analysis, it was also confirmed that the positive electrode active materials of the present invention, which are each a mixture of lithium cobalt oxide and lithium fluoride subjected to annealing, exhibited a paramagnetic property. It was suggested that fluorine is substituted for part of oxygen of lithium cobalt oxide to form LiCoO₂₋ₓFₓ (0.01≤x≤1) in the positive electrode active material of the present invention. Moreover, it was suggested that the positive electrode active material of the present invention includes a bond of cobalt and fluorine.

Furthermore, as described above, in the positive electrode active material of the present invention, the spin concentration at 113 K was higher than the spin concentration at 300 K by 1.1×10⁻⁵ spins/g or more. In a graph of the inverse of the temperature and the spin concentration per cobalt ion plotting the ESR measurement results at 300 K to 113 K, the slope of the approximate straight line of the positive electrode active material of the present invention was more than or equal to 5×10⁻⁶ and less than or equal to 4×10⁻⁵.

### <Fabrication of Secondary Battery>

Next, secondary batteries were fabricated using the positive electrode active materials of Sample 1 and Sample 6.

First, a slurry was formed by mixing the positive electrode active material, AB, and PVDF at the active material:AB:PVDF=95:3:2 (weight ratio), and the slurry was applied onto a current collector of aluminum. As a solvent of the slurry, NMP was used.

After the slurry was applied onto the current collector, the solvent was volatilized. After that, pressure was applied at 210 kN/m, and then, pressure was further applied at 1467 kN/m. Through the above process, the positive electrodes were obtained. The carried amount of the positive electrodes was approximately 7 mg/cm². The density was 3.8 g/cc or higher.

Using the formed positive electrodes, CR2032 type coin battery cells (a diameter of 20 mm, a height of 3.2 mm) were fabricated.

A lithium metal was used for a counter electrode.

As an electrolyte contained in an electrolyte solution, 1 mol/L of lithium hexafluorophosphate (LiPF₆) was used. As the electrolyte solution, a solution in which ethylene carbonate (EC) and diethyl carbonate (DEC) were mixed at EC:DEC=3:7 (volume ratio) was used.

As a separator, 25-μm-thick polypropylene was used.

A positive electrode can and a negative electrode can that were formed using stainless steel (SUS) were used.

### <Rate Performance>

The discharge rate performance of the secondary batteries fabricated in the above-described manner was evaluated. The charge voltage was set to 4.2 V. The measurement temperature was set to 25° C. CC/CV charging (0.2 C, 0.02 Ccut) and CC discharging (0.2 C, 0.5 C, 1 C, 2 C, 3 C, 4 C, or 5 C, 2.5 Vcut) were performed, and a 10-minute break was taken before the next charging. Note that 1 C was 200 mA/g in this example and the like.

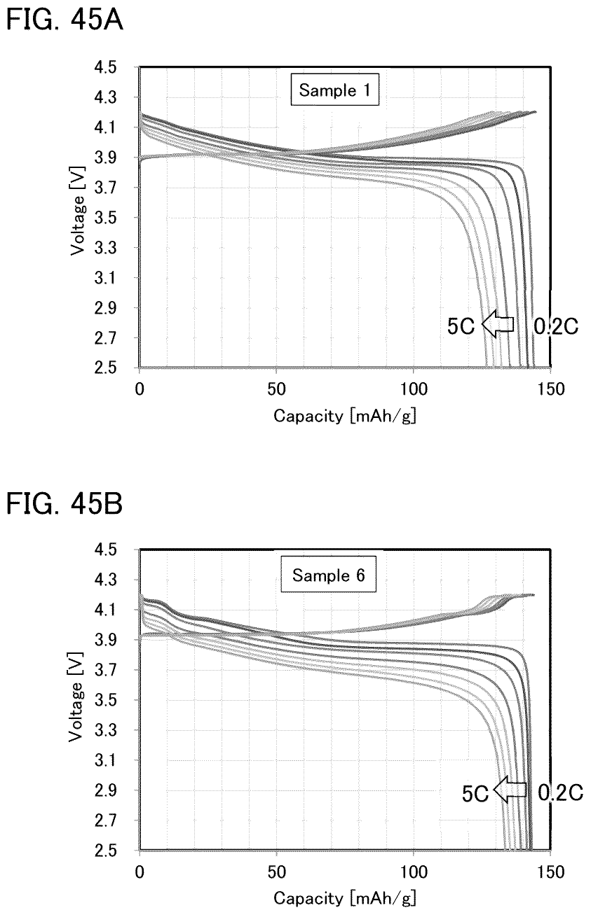

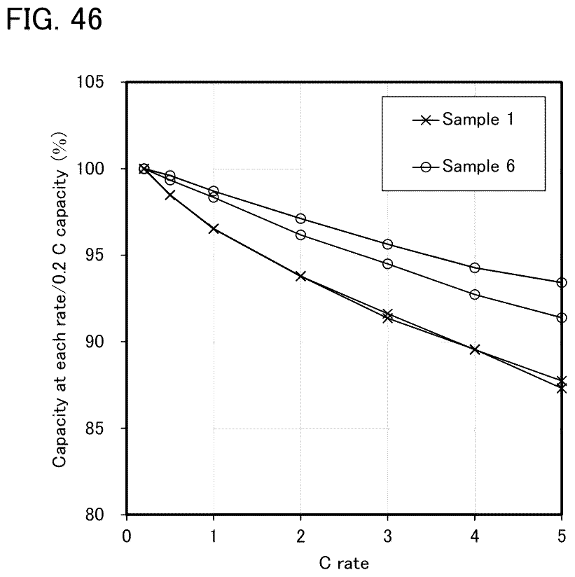

FIG. 45A shows charge and discharge curves of Sample 1 at 0.2 C, 0.5 C, 1 C, 2 C, 3 C, 4 C, and 5 C. FIG. 45B shows charge and discharge curves of Sample 6 at 0.2 C, 0.5 C, 1 C, 2 C, 3 C, 4 C, and 5 C. FIG. 46 shows a graph of the discharge capacity at each discharge rate of Sample 1 and Sample 6, normalized with 0.2 C discharge capacity. The discharge capacity at each discharge rate of Sample 1 and Sample 6 is shown in Table 7. In both FIG. 46 and Table 7, n is 2.

TABLE 7

| | Discharge capacity [mAh/g] | | | |
|---|---|---|---|---|
| | Sample | Sample | Sample | Sample |
| Rate [C] | 1-1 | 1-2 | 6-1 | 6-2 |
| 0.2 | 144.4 | 144.0 | 144.4 | 143.2 |
| 0.5 | 142.2 | 141.8 | 143.4 | 142.6 |
| 1 | 139.4 | 139.0 | 142.0 | 141.3 |
| 2 | 135.4 | 135.1 | 138.9 | 139.1 |
| 3 | 131.9 | 132.0 | 136.5 | 136.9 |
| 4 | 129.3 | 129.0 | 133.9 | 135.0 |
| 5 | 126.1 | 126.4 | 132.0 | 133.8 |

As shown in FIG. 45A, FIG. 45B, and FIG. 46, a decrease in the discharge capacity at high discharge rates was suppressed in Sample 6 annealed after addition of the fluorine source. The effect was apparent compared with Sample 1 which was subjected to annealing without addition. Thus, it was suggested that containing fluorine in the surface portion lowers the lithium extraction energy.

Moreover, it was proved that the positive electrode active material with a spin concentration at 113 K higher than the spin concentration at 300 K by 1.1×10⁻⁵ spins/g or more exhibited a favorable rate performance. Furthermore, in a graph of the inverse of the temperature and the spin concentration per cobalt ion plotting the ESR measurement results at 300 K to 113 K, it was revealed that the positive electrode active material of the present invention with the slope of the approximate straight line of more than or equal to 5×10⁻⁶ exhibited favorable rate performance.

### REFERENCE NUMERALS

90: lithium vacancy, 91: tetravalent cobalt, 92: fluorine-substituted position, 93: divalent cobalt, 100: positive electrode active material

1. (canceled)

2. A manufacturing method of a positive electrode active material, comprising the steps of:
mixing a lithium source and a cobalt source;
performing a heating of the first mixture to obtain a lithium cobalt oxide;
mixing the lithium cobalt oxide and a fluorine source; and
performing a heating of the second mixture,
wherein the heating of the first mixture is performed at a temperature higher than or equal to 800° C. and lower than 1100° C., and for longer than or equal to 2 hours and shorter than or equal to 20 hours, and
wherein when an approximate straight line with three or more measured values at temperatures of higher than or equal to 113 K and lower than or equal to 300 K is drawn in a graph of the inverse of the temperature and a spin concentration per cobalt ion, the slope of the straight line is more than or equal to 5×10⁻⁶ and less than or equal to 4×10⁻⁵.

3. The manufacturing method of a positive electrode active material according to claim 2, wherein the heating of the second mixture is performed at a temperature higher than or equal to 500° C. and lower than 1130° C.

4. The manufacturing method of a positive electrode active material according to claim 2, wherein the positive electrode active material comprises a bond of the cobalt and the fluorine in a surface portion or a vicinity of a grain boundary.

5. A manufacturing method of a positive electrode active material, comprising the steps of:
mixing a lithium source and a cobalt source;
performing a heating of the first mixture to obtain a lithium cobalt oxide;
mixing the lithium cobalt oxide and a fluorine source; and
performing a heating of the second mixture,
wherein the heating of the first mixture is performed at a temperature higher than or equal to 800° C. and lower than 1100° C., and for longer than or equal to 2 hours and shorter than or equal to 20 hours, and
wherein in a range of a g value obtained in an electron spin resonance spectrum of the positive electrode active material of greater than or equal to 2.068 and less than or equal to 2.233, a spin concentration at a temperature of 113 K is higher than a spin concentration at a temperature of 300 K by 1.1×10⁻⁵ spins/g or more.

6. The manufacturing method of a positive electrode active material according to claim 5, wherein the heating of the second mixture is performed at a temperature higher than or equal to 500° C. and lower than 1130° C.

7. The manufacturing method of a positive electrode active material according to claim 5, wherein the positive electrode active material comprises a bond of the cobalt and the fluorine in a surface portion or a vicinity of a grain boundary.

8. A manufacturing method of a positive electrode active material, comprising the steps of:
mixing a lithium source and a cobalt source;
performing a heating of the first mixture to obtain a lithium cobalt oxide;
mixing the lithium cobalt oxide and a fluorine source; and
performing a heating of the second mixture,
wherein the heating of the first mixture is performed at a temperature higher than or equal to 800° C. and lower than 1100° C., and for longer than or equal to 2 hours and shorter than or equal to 20 hours, and
wherein in a range of a g value obtained in an electron spin resonance spectrum of the positive electrode active material of greater than or equal to 2.068 and less than or equal to 2.233, a difference between a spin concentration at a temperature of 300K and a spin concentration at a temperature of 113 K is higher than or equal to 4.0×10⁻⁵ spins/g.

9. The manufacturing method of a positive electrode active material according to claim 8, wherein the heating of the second mixture is performed at a temperature higher than or equal to 500° C. and lower than 1130° C.

10. The manufacturing method of a positive electrode active material according to claim 8, wherein the positive electrode active material comprises a bond of the cobalt and the fluorine in a surface portion or a vicinity of a grain boundary.
